(19) United States
(12) Patent Application Publication
(10) Pub. No.: US 2026/0361384 A1
(43) Pub. Date: Nov. 12, 2026

(54) BEAM REFINEMENT FOR CANDIDATE OR STICKY BEAMS IN DEVICES WITH MOVEABLE ANTENNA PANELS

(71) Applicant: QUALCOMM Incorporated, San Diego, CA (US)

(72) Inventors: Vasanthan RAGHAVAN, West Windsor Township, NJ (US); Tao LUO, San Diego, CA (US); Yu-Chin OU, San Diego, CA (US); Junyi LI, Greentown, PA (US)

(21) Appl. No.: 19/636,541

(22) Filed: Apr. 1, 2026

Related U.S. Application Data
(60) Provisional application No. 63/804,222, filed on May 12, 2025.
(60) Provisional application No. 63/804,217, filed on May 12, 2025.

(51) Int. Cl. H04B 7/06

(52) U.S. Cl. CPC H04B 7/06958

(57) ABSTRACT

A method for wireless communication at a user equipment (UE) and related apparatus are provided. In the method, the UE transmits to a network entity beam information including a set of candidate beams for a first antenna panel and a second antenna panel of the UE. The set of candidate beams is associated with a set of valid time-period ranges, and the set of valid time-period ranges indicates time-periods of validity for the set of candidate beams. The UE further performs a beam refinement process with the network entity for coherent communication with the first antenna panel and the second antenna panel based on the beam information.

### CROSS REFERENCE TO RELATED APPLICATION(S)

The present application for patent claims priority under 35 U.S.C. § 119 to U.S. Provisional Patent Application No. 63/804,222, filed on May 12, 2025, and entitled “BEAM REFINEMENT FOR CANDIDATE OR STICKY BEAMS IN DEVICES WITH MOVEABLE ANTENNA PANELS,” and to U.S. Provisional Patent Application No. 63/804,217, filed on May 12, 2025, and entitled “SEMI-DETERMINISTIC BEAM MANAGEMENT IN DEVICES WITH MOVEABLE ANTENNA PANELS,” each of which is assigned to the assignee hereof and is hereby expressly incorporated by reference herein in its entirety.

### TECHNICAL FIELD

The present disclosure relates generally to communication systems and, more particularly, to update the beams via beam refinement processes in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. Some aspects of later wireless communication, such as 6G or others, may be based on aspects of 5G NR and/or 4G LTE. There exists a need for further improvements in 5G NR technology and additional wireless communication technology, including future wireless communication technologies, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to transmit, to a network entity, beam information including a set of candidate beams for a first antenna panel and a second antenna panel of the UE, where the set of candidate beams is associated with a set of valid time-period ranges, and where the set of valid time-period ranges indicates time-periods of validity for the set of candidate beams; and perform, based on the beam information, a beam refinement process with the network entity for a coherent communication with the first antenna panel and the second antenna panel.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to receive, from a UE, beam information including a set of candidate beams for a first antenna panel and a second antenna panel of the UE, where the set of candidate beams is associated with a set of validity time ranges, and where the set of validity time ranges indicates validity periods for the set of candidate beams; and perform, based on the beam information, a beam refinement process with the UE for at least one of the first antenna panel and the second antenna panel.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

The systems, methods, and devices of this disclosure each have several innovative aspects, no single one of which is solely responsible for the desirable attributes disclosed herein.

Some aspects described herein relate to a wireless communication device. The wireless communication device may include a processing system. The processing system may include one or more processors and one or more code-storing memories coupled with the one or more processors. The processing system may be configured to cause the wireless communication device to communicate, with a network node using a plurality of antenna panels including a first antenna panel at a first location, one or more messages via a first communication beam corresponding to a first beam steering direction. The processing system may be configured to cause the wireless communication device to perform a mechanical displacement of the first antenna panel from the first location to a second location. The processing system may be configured to cause the wireless communication device to perform a beam refinement procedure for the plurality of antenna panels including the first antenna panel at the second location to select a second communication beam in coordination with a third communication beam associated with a second antenna panel. The processing system may be configured to cause the wireless communication device to communicate, with the network node using the first antenna panel at the second location, one or more messages via the second communication beam corresponding to a second beam steering direction that is correlated to the first beam steering direction according to a local coordinate system of the wireless communication device.

Some aspects described herein relate to a network node. The network node may include a processing system. The processing system may include one or more processors and one or more code-storing memories coupled with the one or more processors. The processing system may be configured to cause the network node to communicate, with a wireless communication device that is using a plurality of antenna panels including a first antenna panel at a first location, one or more messages via a first communication beam that corresponds to a first beam steering direction. The processing system may be configured to cause the network node to perform, via one or more communications with the wireless communication device, a beam refinement procedure for communicating with the plurality of antenna panels including the first antenna panel at a second location to select a second communication beam in coordination with a third communication beam that is associated with a second antenna panel. The processing system may be configured to cause the network node to communicate, with the wireless communication device that is using the first antenna panel at the second location, one or more messages via the second communication beam corresponding to a second beam steering direction that is correlated to the first beam steering direction according to a local coordinate system of the wireless communication device.

Some aspects described herein relate to a method of wireless communication performed by a wireless communication device. The method may include communicating, with a network node using a plurality of antenna panels including a first antenna panel at a first location, one or more messages via a first communication beam corresponding to a first beam steering direction. The method may include performing a mechanical displacement of the first antenna panel from the first location to a second location. The method may include performing a beam refinement procedure for the plurality of antenna panels including the first antenna panel at the second location to select a second communication beam in coordination with a third communication beam associated with a second antenna panel. The method may include communicating, with the network node using the first antenna panel at the second location, one or more messages via the second communication beam corresponding to a second beam steering direction that is correlated to the first beam steering direction according to a local coordinate system of the wireless communication device.

Some aspects described herein relate to a method of wireless communication performed by a network node. The method may include communicating, with a wireless communication device that is using a plurality of antenna panels including a first antenna panel at a first location, one or more messages via a first communication beam that corresponds to a first beam steering direction. The method may include performing, via one or more communications with the wireless communication device, a beam refinement procedure for communicating with the plurality of antenna panels including the first antenna panel at a second location to select a second communication beam in coordination with a third communication beam that is associated with a second antenna panel. The method may include communicating, with the wireless communication device that is using the first antenna panel at the second location, one or more messages via the second communication beam corresponding to a second beam steering direction that is correlated to the first beam steering direction according to a local coordinate system of the wireless communication device.

Some aspects described herein relate to a non-transitory computer-readable medium that stores a set of instructions for wireless communication by a wireless communication device. The set of instructions, when executed by one or more processors of the wireless communication device, may cause the wireless communication device to communicate, with a network node using a plurality of antenna panels including a first antenna panel at a first location, one or more messages via a first communication beam corresponding to a first beam steering direction. The set of instructions, when executed by one or more processors of the wireless communication device, may cause the wireless communication device to perform a mechanical displacement of the first antenna panel from the first location to a second location. The set of instructions, when executed by one or more processors of the wireless communication device, may cause the wireless communication device to perform a beam refinement procedure for the plurality of antenna panels including the first antenna panel at the second location to select a second communication beam in coordination with a third communication beam associated with a second antenna panel. The set of instructions, when executed by one or more processors of the wireless communication device, may cause the wireless communication device to communicate, with the network node using the first antenna panel at the second location, one or more messages via the second communication beam corresponding to a second beam steering direction that is correlated to the first beam steering direction according to a local coordinate system of the wireless communication device.

Some aspects described herein relate to a non-transitory computer-readable medium that stores a set of instructions for wireless communication by a network node. The set of instructions, when executed by one or more processors of the network node, may cause the network node to communicate, with a wireless communication device that is using a plurality of antenna panels including a first antenna panel at a first location, one or more messages via a first communication beam that corresponds to a first beam steering direction. The set of instructions, when executed by one or more processors of the network node, may cause the network node to perform, via one or more communications with the wireless communication device, a beam refinement procedure for communicating with the plurality of antenna panels including the first antenna panel at a second location to select a second communication beam in coordination with a third communication beam that is associated with a second antenna panel. The set of instructions, when executed by one or more processors of the network node, may cause the network node to communicate, with the wireless communication device that is using the first antenna panel at the second location, one or more messages via the second communication beam corresponding to a second beam steering direction that is correlated to the first beam steering direction according to a local coordinate system of the wireless communication device.

Some aspects described herein relate to an apparatus for wireless communication. The apparatus may include means for communicating, with a network node using a plurality of antenna panels including a first antenna panel at a first location, one or more messages via a first communication beam corresponding to a first beam steering direction. The apparatus may include means for performing a mechanical displacement of the first antenna panel from the first location to a second location. The apparatus may include means for performing a beam refinement procedure for the plurality of antenna panels including the first antenna panel at the second location to select a second communication beam in coordination with a third communication beam associated with a second antenna panel. The apparatus may include means for communicating, with the network node using the first antenna panel at the second location, one or more messages via the second communication beam corresponding to a second beam steering direction that is correlated to the first beam steering direction according to a local coordinate system of the wireless communication device.

Some aspects described herein relate to an apparatus for wireless communication. The apparatus may include means for communicating, with a wireless communication device that is using a plurality of antenna panels including a first antenna panel at a first location, one or more messages via a first communication beam that corresponds to a first beam steering direction. The apparatus may include means for performing, via one or more communications with the wireless communication device, a beam refinement procedure for communicating with the plurality of antenna panels including the first antenna panel at a second location to select a second communication beam in coordination with a third communication beam that is associated with a second antenna panel. The apparatus may include means for communicating, with the wireless communication device that is using the first antenna panel at the second location, one or more messages via the second communication beam corresponding to a second beam steering direction that is correlated to the first beam steering direction according to a local coordinate system of the wireless communication device.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings and the appendix. Details of one or more implementations of the subject matter described in this disclosure are set forth in the accompanying drawings, the appendix, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example customer premises equipment (CPE) with a mechanically displaceable antenna.

FIG. 5 is a diagram illustrating an example of coordinated communication using multiple antenna panels of a UE.

FIG. 6 is a diagram illustrating an example of the update on the set of sticky beams in accordance with various aspects of the present disclosure.

FIG. 7 is a call flow diagram illustrating a method of wireless communication in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a UE in accordance with various aspects of the present disclosure.

FIG. 10 is a flowchart illustrating methods of wireless communication at a network entity in accordance with various aspects of the present disclosure.

FIG. 11 is a flowchart illustrating methods of wireless communication at a network entity in accordance with various aspects of the present disclosure.

FIG. 12 is a diagram illustrating an example of a hardware implementation for an example apparatus and/or UE.

FIG. 13 is a diagram illustrating an example of a hardware implementation for an example network entity.

FIG. 14 is a diagram illustrating an example of a wireless communication network.

FIG. 15 is a diagram illustrating an example of a millimeter wave (mmW) device in accordance with the present disclosure.

FIG. 16 is a diagram illustrating an example of a mmW device with adjustable antenna panels in accordance with the present disclosure.

FIG. 17 is a diagram illustrating an example of directional communications between a customer premises equipment and a network node, in accordance with the present disclosure.

FIG. 18 is a diagram of an example associated with semi-deterministic beam management in devices with moveable antenna panels.

FIG. 19 is a diagram illustrating an example associated with sticky beam determination, in accordance with the present disclosure.

FIG. 20 is a diagram illustrating an example process performed, for example, at a wireless communication device or an apparatus of a wireless communication device.

FIG. 21 is a diagram illustrating an example process performed, for example, at a network node or an apparatus of a network node.

FIG. 22 is a diagram of an example apparatus for wireless communication.

FIG. 23 is a diagram of an example apparatus for wireless communication.

### DETAILED DESCRIPTION

In wireless communication, customer premises equipment (CPEs) are evolving from the use of large antenna array configurations to smaller, more cost-effective antenna arrays in some low-cost, amenable markets. To maintain a high array gain and high effective isotropic radiated power (EIRP) without relying on large antenna arrays, these configurations often incorporate the use of a Cassegrain (or other types) of reflectors. However, since the scan range of a smaller antenna array is reduced, to cover the entire coverage area as a design with a larger antenna array, a mechanical rotator is used to reposition a moveable antenna panel. This approach not only enhances array gain but also helps to maintain a similar scan range as a larger antenna array-based design. Thus, this overall design can reduce cost, power consumption, and associated thermal overhead, and still maintain a similar/comparable performance in terms of EIRP and scan ranges. When an antenna panel moves from one position to another, a beam search across those panels may be performed to enable joint or coordinated communications based on these antenna panels. However, conventional beam management approaches, such as performing beam searches across different beams from each of the multiple panels for enhanced performance, may result in significant beam training overhead. Example aspects presented herein provide methods and apparatus for network configured “sticky” beams (or candidate beams) to support beam update and beam refinement processes in devices with moveable antenna panels.

Various aspects relate generally to wireless communication. Some aspects more specifically relate to beam update and beam refinement processes in wireless communication. In some examples, a CPE (or user equipment (UE)) transmits to a network entity beam information including a set of candidate beams for a first antenna panel and a second antenna panel of the UE. The set of candidate beams may be associated with a set of valid time-period ranges, and the set of valid time-period ranges may indicate time-periods of validity for the set of candidate beams. The UE further performs a beam refinement process with the network entity for a coherent and coordinated communication with the first antenna panel and the second antenna panel based on the beam information. In some examples, at least one of the first antenna panel and the second antenna panel may be a mechanically displaceable panel. In some examples, the UE may receive from the network entity a request for the valid time-period ranges for the set of candidate beams, and the UE may transmit an indication of the set of valid time-period ranges for the set of candidate beams in response to the request. In some examples, the UE may further transmit to the network entity a second set of candidate beams. The second set of candidate beams may be associated with a second set of valid time-period ranges that is later than the previous set of valid time-period ranges. In some examples, the network entity may configure a beam refinement indication that triggers the beam refinement process for the UE, and the beam refinement indication may be based on an expiry of a timer. The expiry of the timer may be based on, for example, an absolute time threshold, the speed of the motor used with the mechanically displaceable panel, a beam coherence time estimation associated with a channel quality, or a quality metric for communication between the UE and the network entity.

Particular aspects of the subject matter described in this disclosure can be implemented to realize one or more of the following potential advantages. In some examples, by introducing a network-configured “sticky” beam (or candidate beam) framework and enabling the network to request and manage time-validity information for the sticky beams, the described techniques can be used to reduce the overhead in beam update or beam refinement processes for devices using mechanically moveable antenna panels. In some examples, by enabling network-controlled timers for triggering (or retriggering) beam refinement based on motor speed, coherence, or signal quality, the described techniques can be used to adaptively maintain beam alignment under changing environmental or geometrical conditions, thereby reducing unnecessary overhead and improving user experience. In some examples, by allowing the network to place restrictions on beam updates based on control channel overhead, the described techniques can be used to balance performance gains with signaling load, thereby maintaining reliable wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

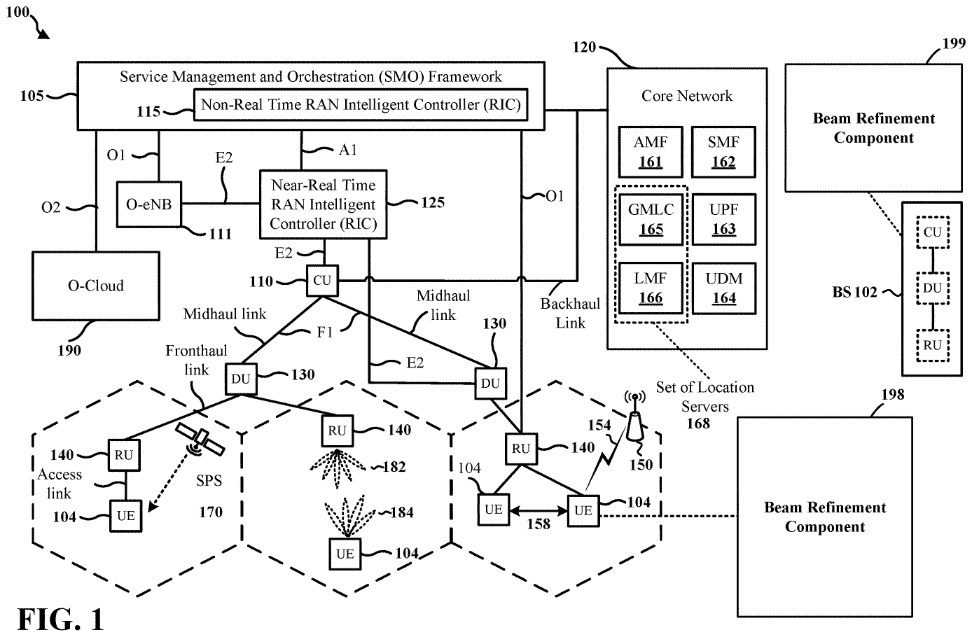

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHz-24.25 GHz), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the beam refinement component 198. The beam refinement component 198 may be configured to transmit, to a network entity, beam information including a set of candidate beams for a first antenna panel and a second antenna panel of the UE, where the set of candidate beams is associated with a set of valid time-period ranges, and where the set of valid time-period ranges indicates time-periods of validity for the set of candidate beams; and perform, based on the beam information, a beam refinement process with the network entity for a coherent communication with the first antenna panel and the second antenna panel. In certain aspects, the base station 102 may include the beam refinement component 199. The beam refinement component 199 may be configured to receive, from a UE, beam information including a set of candidate beams for a first antenna panel and a second antenna panel of the UE, where the set of candidate beams is associated with a set of validity time ranges, and where the set of validity time ranges indicates validity periods for the set of candidate beams; and perform, based on the beam information, a beam refinement process with the UE for at least one of the first antenna panel and the second antenna panel. Although the following description may give examples based on 5G NR to illustrate concepts relating to wireless communication, the concepts described herein may be applicable to other similar areas, such as LTE, LTE-A, CDMA, GSM, 6G and other wireless technologies.

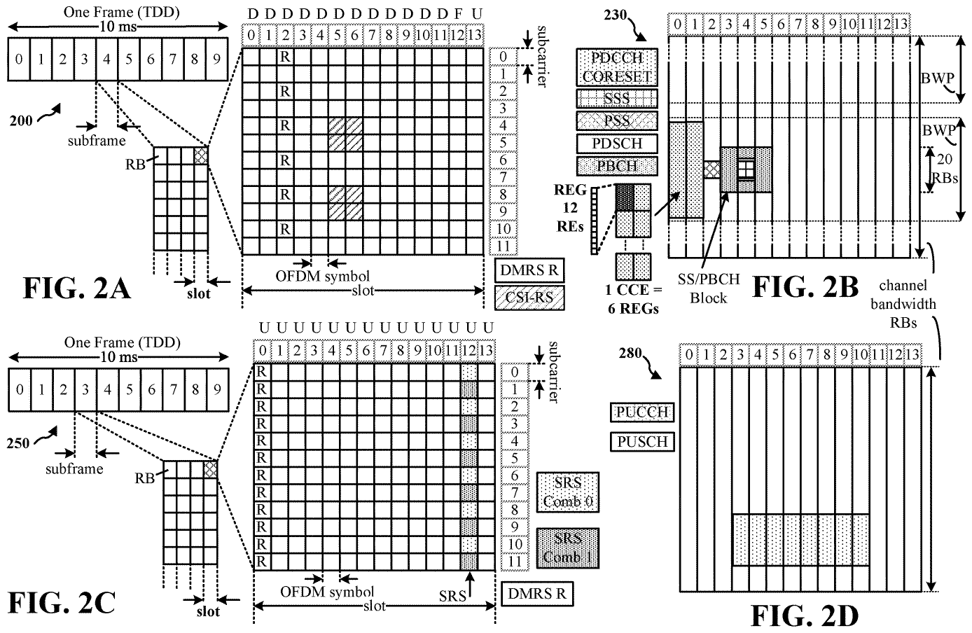

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The examples in FIGS. 2A-2D show example aspects of a frame structure based on 5G NR to illustrate the concept of a frame structure and wireless communication based on a frame structure. Various aspects described in connection with FIGS. 2A-2D may also be used in connection with other wireless communication technologies, such as 6G among other examples. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15 [KHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

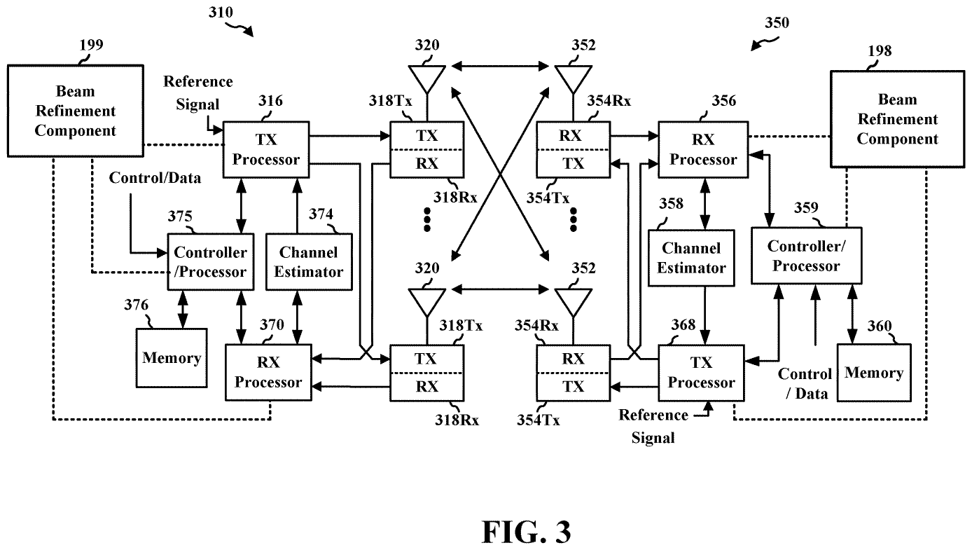

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the beam refinement component 198 of FIG. 1.

At least one of the TX processor 316, the RX processor 370, and the controller/processor 375 may be configured to perform aspects in connection with the beam refinement component 199 of FIG. 1.

In wireless communication, customer premises equipment (CPEs) are evolving from the use of large antenna array configurations, such as 8×8, 16×8, and 16×16 configurations, to smaller arrays, more cost-effective antenna array configurations in some markets. To maintain high equivalent isotropically radiated power (EIRP) or array gain without relying on large antenna arrays, these configurations often incorporate a reflector (e.g., a Cassegrain reflector) or a mechanical rotator to realize mechanically moveable antenna panels. This approach enhances array gain and also helps to reduce power consumption and thermal overhead. When an antenna panel moves from one position to another, a beam search across those panels may be performed to enable joint or coordinated communications based on these antenna panels. However, conventional beam management approaches, such as performing beam searches across different beams from each of the multiple panels for enhanced performance, may result in significant beam training overhead. In some examples, a set of candidate beams, which may also be referred to as “sticky beams,” may be conveyed by the CPE to the base station, and the set of candidate beams (or sticky beams) may facilitate the beam update or beam refinement processes across multiple antenna panels. Example aspects presented herein provide methods and apparatus for network configured sticky beams to support beam update and beam refinement processes in devices with moveable antenna panels. As used herein, the term “sticky beams” may also be used interchangeably with “candidate beams.”

In some examples, CPE may be equipped with a built-in mechanical displacement apparatus, which may include, for example, at least one motor capable of rotating, reflecting, or displacing the antenna panels. This design enables low-cost operations of the antennas. For example, a simplified CPE design may be used to mechanically separate or displace the panels within the CPE by a known amount. The displacement can take various forms, including linear displacement along the horizontal axis (e.g., the X axis), the vertical axis (e.g., the Y axis), or both axes. In some examples, the displacement may include angular displacement, which involves rotation from one location to another.

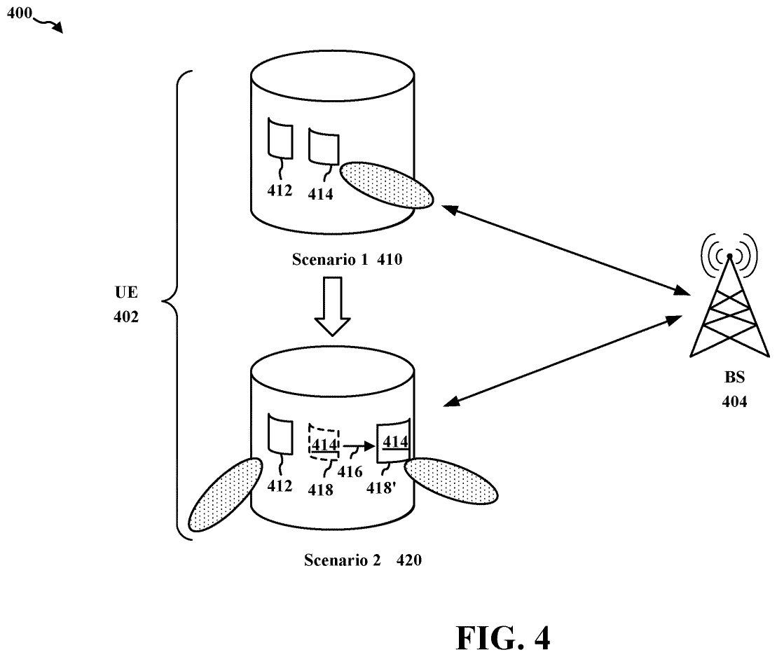

FIG. 4 is a diagram 400 illustrating an example CPE with a mechanically displaceable antenna. As shown in FIG. 4, the UE 402 is an example CPE with a mechanically displaceable (moveable) antenna. The UE 402 may include two antenna panels, such as antenna panel 1 412 and antenna panel 2 414, where antenna panel 2 414 may be a mechanically displaceable (moveable) antenna. FIG. 4 shows two scenarios (e.g., scenario 1 510 and scenario 2 420) for the operation of the UE 402 using the two antenna panels (e.g., antenna panel 1 412, antenna panel 2 414). In scenario 1 410, the two antenna panels (e.g., antenna panel 1 412, antenna panel 2 414) are co-located panels, and they may be used for single-user communications with a single node, such as a single node of base station 404. In scenario 2 420, the antenna panel 414 may be displaced (moved) from the original position 418 to a new position at 418′ via 416, driven by, for example, a mechanical motor. As a result, the two antenna panels (e.g., antenna panel 1 412, antenna panel 2 414 at position 418′) become non-co-located panels, and they may be used for communications with multiple nodes.

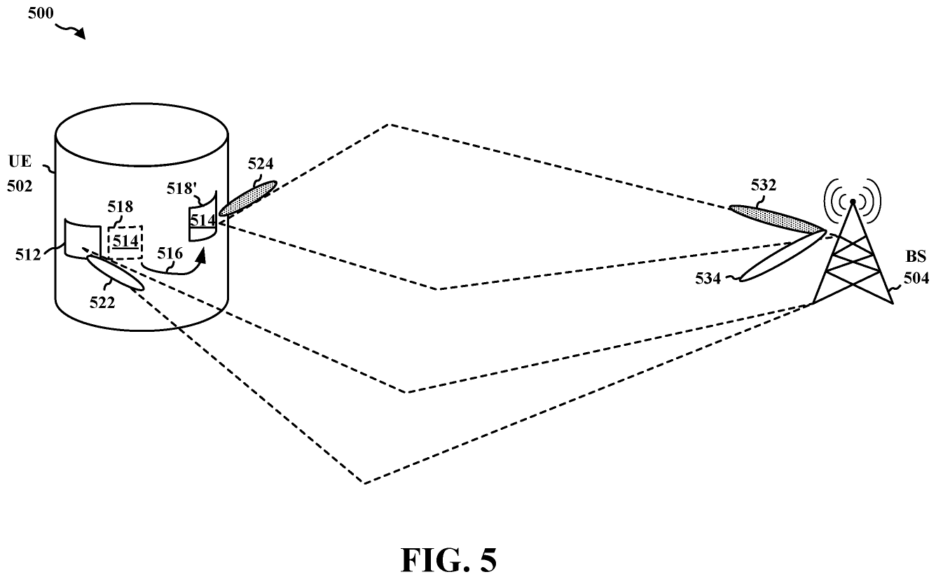

In some examples, CPEs (or UE) with moveable antenna panels, such as UE 402 with moveable antenna panel 414, may be used as a cost-effective alternative to more expensive devices with larger antenna array configurations. To enhance cell edge coverage, both or multiple panels within the CPE can coordinate their beams over a single layer, thereby achieving an enhanced signal-to-noise ratio (SNR). In some examples, to enhance cell edge coverage, both or multiple panels within the CPE may coordinate their beams over a single layer to achieve coordinated communication for enhanced signal-to-noise ratio (SNR). FIG. 5 is a diagram 500 illustrating an example of coordinated communication using multiple antenna panels of a UE. As shown in FIG. 5, the UE 502 is an example CPE equipped with at least one mechanically displaceable (moveable) antenna panel. For example, the UE 502 may include two antenna panels, such as antenna panel 1 512 and antenna panel 2 514, where antenna panel 2 514 may be a mechanically displaceable (moveable) antenna. For example, the antenna panel 2 514 may be capable of moving (e.g., via 516) from its original location 518 to a new location at 518′. As shown in FIG. 5, to enhance cell edge coverage, the antenna panels (e.g., antenna panel 1 512, antenna panel 2 514) within the UE 502 may coordinate their beams (e.g., beam 524 for antenna panel 2 514 at position 518′, beam 522 for antenna panel 1 512) over a single layer, thereby achieving an enhanced SNR. For example, beam 524 for antenna panel 2 514 at position 518′ may correspond to beam 532 for base station 504, and beam 522 for antenna panel 1 512 may correspond to beam 534 for base station 504.

In some aspects, a joint beam search from multiple panels (e.g., antenna panel 1 512, antenna panel 2 514) may be performed for coordinated communication among these antenna panels to enhance key performance indicators (KPIs) of the communication. This joint beam search process may be based on the minimization of inter-beam interference. In some examples, a joint beam search may involve beam configuration at the base station (e.g., base station 504), followed by the determination of inter-beam interference. However, this beam search scheme may result in significant overhead.

In some examples, the CPE (or UE), such as UE 502, may provide information on potential candidate beams (or sticky beams) to the base station (e.g., base station 504). These sticky beams (candidate beams) may include relevant candidate beams that are applicable across different panels (e.g., antenna panel 1 512, antenna panel 2 514). Beamforming optimization using this set of sticky beams (candidate beams) may reduce the overhead associated with beam training. Some example aspects presented herein provide methods and apparatus for network configured mechanisms for efficiently learning the set of sticky beams (candidate beams).

In some examples, after the CPE (e.g., UE 502) initially provides a set of sticky (or candidate) beams, such as a set of sticky synchronization signal block (SSB) beams), to be used across multiple panels (e.g., antenna panel 1 512, antenna panel 2 514), the effectiveness of these sticky beams may degrade over time. This degradation can occur due to changes in the channel environment, fading conditions, or local geometry. Hence, certain signaling mechanisms may be provided to maintain the accuracy and relevance of the sticky beams (candidate beams).

In some aspects, the base station (e.g., base station 504) may request information from the CPE device (e.g., UE 502) regarding the duration for which the sticky beams remain effective. In some examples, the base station (e.g., base station 504) may request the time ranges over which the sticky beams are considered valid. In some aspects, these time ranges may be referred to as the “valid time-period ranges,” which may specify a time period or a time range during which the stick beams may be used for beam update or beam refinement purposes.

In some aspects, upon receiving the request from the base station (e.g., base station 504), the CPE device (e.g., UE 502) may respond in different ways. In one configuration, the CPE device (e.g., UE 502) may convey the specific time ranges (e.g., valid time-period ranges) during which the sticky beams are applicable (e.g., for beam update or beam refinement purposes). In another configuration, the CPE device (e.g., UE 502) may provide a new set of sticky beams that are valid beyond the initially indicated time range. For example, the CPE device (e.g., UE 502) may transmit to the base station 504 a second set of sticky beams (candidate beams). The second set of candidate beams may be associated with a second set of valid time-period ranges, and the second set of valid time-period ranges may occur later than the set of valid time-period ranges associated with the previously transmitted set of sticky beams sent earlier.

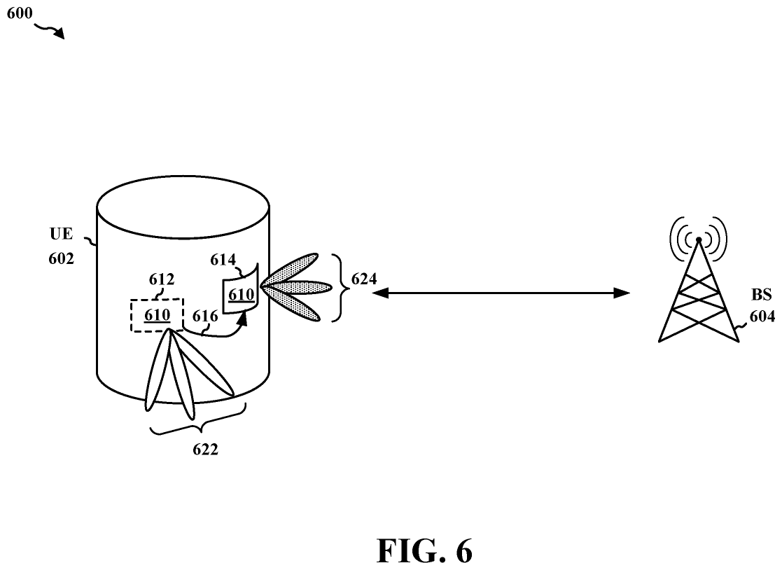

FIG. 6 is a diagram 600 illustrating an example of the update on the set of sticky beams in accordance with various aspects of the present disclosure. As shown in FIG. 6, the UE 602 is an example CPE equipped with a mechanically displaceable (moveable) antenna panel. For example, the UE 602 may include a mechanically moveable antenna panel 610, which may move from an original position 612 to a new position at 614 (e.g., via 616). The UE 602 may transmit to the base station 604 a first set of sticky beams 622, corresponding to the original position 612 of antenna panel 610. The first set of sticky beams 622 may have valid time-period ranges, indicating the time ranges for which the first set of sticky beams 622 is considered valid for beam update or beam refinement purposes. Subsequently, the UE 602 may transmit to the base station 604 a second set of sticky beams 624. For example, the second set of sticky beams 624 may correspond to the new position 614 of antenna panel 610. The second set of sticky beams 624 may be associated with a second set of valid time-period ranges, and the second set of valid time-period ranges may occur later than the set of valid time-period ranges associated with the previously transmitted set of sticky beams 622.

In another configuration, as a more generalized framework, the CPE device (e.g., UE 502) may provide a set of sticky beams along with the corresponding applicable time ranges (e.g., valid time-period ranges) for each of those beams. In some examples, the selection of the sticky beams may be based on the prediction performed by the CPE device (e.g., UE 502).

In some aspects, a base station (e.g., base station 504) may trigger (or retrigger) beam refinement based on the expiry of a timer. For example, this timer can be configured in several ways. In one configuration, the timer may be determined based on an absolute time threshold, which may be indicated a priori by the base station (e.g., base station 504). For example, the timer may expire when the absolute time threshold has been reached. In another configuration, the timer may be determined based on the motor speed associated with the displacement of the antenna panels (e.g., the displacement of antenna panel 610 via 616). For example, the timer may expire more quickly for an antenna panel driven by a faster motor compared to another antenna panel with a slower motor speed. In another configuration, the timer may be determined based on beam coherence estimates derived from past performance. For example, the timer may be determined based on a beam coherence time estimation for beams associated with the first antenna panel (e.g., antenna panel 1 512) or the second antenna panel (e.g., antenna panel 2 514) at a prior time that is before the expiry of the timer. In another configuration, the timer may be triggered based on specific rules. For example, the timer may be triggered based on a quality metric for communication between the UE (e.g., UE 502) and the network entity (e.g., base station 504). For example, the quality metric may include the reference signal received power (RSRP) of a signal between the UE (e.g., UE 502) and the base station (e.g., base station 504) or the change of the strength of the signal between the UE (e.g., UE 502) and the base station (e.g., base station 504). For example, the timer may be triggered if uplink (or downlink) performance degrades beyond a certain threshold, such as when the change in RSRP exceeds an RSRP threshold, or when the change in signal strength exceeds a signal strength threshold.

In some aspects, the base station (e.g., base station 504) may determine whether to perform the beam update or beam refinement process based on the network condition. For example, the base station (e.g., base station 504) may impose a restriction on updates to the set of sticky beams and on beam refinement procedures based on control channel overhead considerations. For example, the base station (e.g., base station 504) may transmit to the UE (e.g., UE 502) an indication of a beam update restriction based on the communication overhead on the control channel between the UE (e.g., UE 502) and the base station (e.g., base station 504). This restriction may be triggered, for example, when the communication overhead exceeds an overhead threshold. In response to the beam update restriction, the UE (e.g., UE 502) and the base station (e.g., base station 504) may refrain from (or stop) performing the beam refinement process.

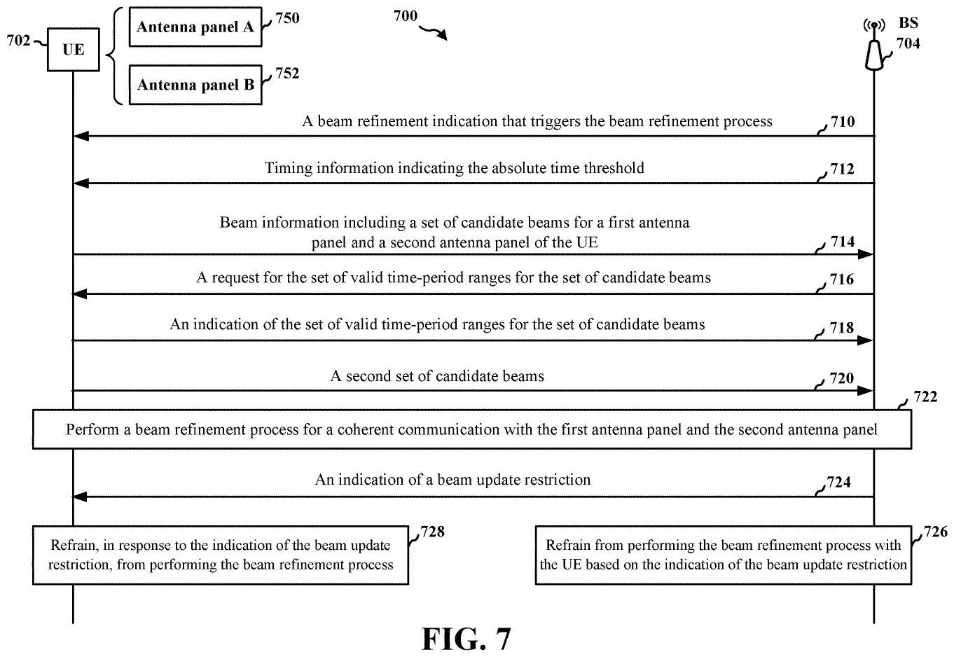

FIG. 7 is a call flow diagram 700 illustrating a method of wireless communication in accordance with various aspects of this present disclosure. Various aspects are described in connection with a UE 702 and a base station 704. The aspects may be performed by the UE 702 or the base station 704 in aggregation and/or by one or more components of a base station 704 (e.g., a CU 110, a DU 130, and/or an RU 140). In some examples, the UE 702 may have one or more antenna panels, such as antenna panel A 750, antenna panel B 752. At least one of these antenna panels (e.g., antenna panel A 750, antenna panel B 752) may be a mechanically displaceable panel. For example, the UE 702 may be UE 502, 602. The base station 704 may be base station 504, 604.

As shown in FIG. 7, at 710, the UE 702 may receive from base station 704 a beam refinement indication. The beam refinement indication may trigger the beam refinement process between the UE 702 and base station 704 (e.g., at 722). In some examples, the beam refinement indication is based on an expiry of a timer. The timer may be based on, for example, an absolute time threshold, the speed of the mechanically displaceable panel in UE 702, a beam coherence time estimation for beams associated with the antenna panels (e.g., antenna panel A 750, antenna panel B 752) at a prior time that is before the expiry of the timer, or a quality metric for communication between the UE 702 and the base station 704.

At 712, the UE 702 may receive from the base station 704 timing information. The timing information may indicate the absolute time threshold for the timer.

At 714, the UE 702 may transmit to base station 704 beam information including a set of candidate beams for a first antenna panel (e.g., antenna panel A 750) and a second antenna panel (e.g., antenna panel B 752) of the UE 702. The set of candidate beams may be associated with a set of valid time-period ranges, and the set of valid time-period ranges indicates time-periods of validity for the set of candidate beams. For example, referring to FIG. 6, the UE 602 may transmit to base station 604 beam information including a set of candidate beams (e.g., the set of sticky beams 622) for antenna panel 610. The set of candidate beams (e.g., the set of sticky beams 622) may be associated with a set of valid time-period ranges that indicates time-periods of validity for the set of candidate beams.

At 716, the UE 702 may receive from the base station 704 a request for the set of valid time-period ranges for the set of candidate beams. For example, referring to FIG. 6, the UE 602 may receive from the base station 604 a request for the set of valid time-period ranges for the set of candidate beams (e.g., the set of sticky beams 622).

At 718, the UE 702 may transmit, in response to the request, an indication of the set of valid time-period ranges for the set of candidate beams. For example, referring to FIG. 6, the UE 602 may transmit, in response to the request, an indication of the set of valid time-period ranges for the set of candidate beams (e.g., the set of sticky beams 622).

At 720, the UE 702 may transmit to the base station 704 a second set of candidate beams. The second set of candidate beams may be associated with a second set of valid time-period ranges, which occur later than the valid time-period ranges for the previously transmitted set of candidate beams. For example, referring to FIG. 6, the UE 602 may transmit to the base station 604 a second set of candidate beams (e.g., the set of sticky beams 624). The second set of candidate beams (e.g., the set of sticky beams 624) may be associated with a second set of valid time-period ranges, which occur later than the valid time-period ranges for the previously transmitted set of candidate beams (e.g., the set of sticky beams 622).

At 722, the UE 702 and the base station 704 may perform a beam refinement process for coherent communication with the first antenna panel (e.g., antenna panel A 750) and the second antenna panel (e.g., antenna panel B 752) based on the beam information (e.g., at 714).

At 724, the base station 704 may transmit to the UE 702 an indication of a beam update restriction. For example, the beam update restriction may be sent based on a communication overhead on a control channel between the UE 702 and the base station 704. Based on the indication of the beam update restriction, the base station 704 may, at 726, refrain from (or stop) performing the beam refinement process with the UE 702.

At 728, upon receiving the beam update restriction, the UE 702 may refrain from (or stop) performing the beam refinement process.

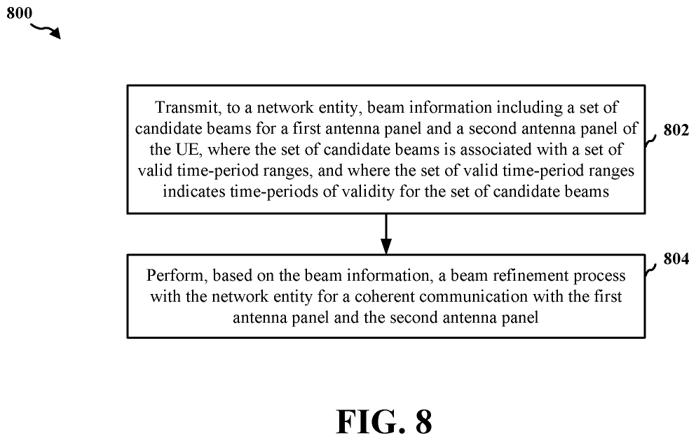

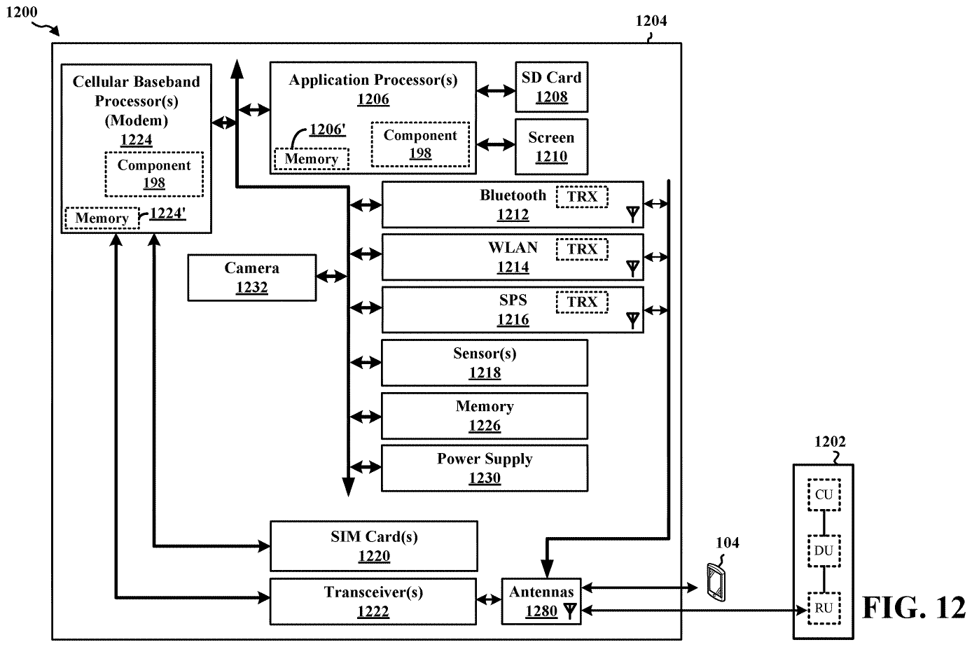

FIG. 8 is a flowchart 800 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 504, 604, 704; or the network entity 1202 in the hardware implementation of FIG. 12). The UE may be the UE 104, 350, 502, 602, 702, or the apparatus 1204 in the hardware implementation of FIG. 12. In some examples, the UE may have one or more antenna panels, such as antenna panel A 750, antenna panel B 752. At least one of these antenna panels (e.g., antenna panel A 750, antenna panel B 752) may be a mechanically displaceable panel. By introducing a network-configured “sticky” beam (or candidate beam) framework and enabling the network to request and manage time-validity information for the sticky beams, the methods reduce the overhead in beam update or beam refinement processes for devices using mechanically moveable antenna panels. Additionally, by enabling network-controlled timers for triggering (or retriggering) beam refinement based on factors such as motor speed, coherence, or signal quality, the methods can be used to adaptively maintain beam alignment under changing environmental or geometrical conditions, thereby reducing unnecessary overhead and improving user experience. In some examples, by allowing the network to place restrictions on beam update and beam refinement processes based on control channel overhead, the methods can be used to balance performance gains with signaling load, thereby maintaining reliable wireless communication.

As shown in FIG. 8, at 802, the UE may transmit to a network entity beam information including a set of candidate beams for a first antenna panel and a second antenna panel of the UE. The set of candidate beams may be associated with a set of valid time-period ranges, and the set of valid time-period ranges indicates time-periods of validity for the set of candidate beams. FIG. 5, FIG. 6, and FIG. 7 illustrate various aspects of the steps in connection with flowchart 800. For example, referring to FIG. 7, the UE 702 may, at 714, transmit to a network entity (e.g., base station 704) beam information including a set of candidate beams for a first antenna panel (e.g., antenna panel A 750) and a second antenna panel (e.g., antenna panel B 752) of the UE 702. The set of candidate beams may be associated with a set of valid time-period ranges, and the set of valid time-period ranges indicates time-periods of validity for the set of candidate beams. In some aspects, 802 may be performed by the beam refinement component 198.

At 804, the UE may perform, based on the beam information, a beam refinement process with the network entity for coherent communication with the first antenna panel and the second antenna panel. For example, referring to FIG. 7, the UE 702 may, at 722, perform a beam refinement process with the network entity (e.g., base station 704) for coherent communication with the first antenna panel (e.g., antenna panel A 750) and the second antenna panel (e.g., antenna panel B 752) based on the beam information (e.g., at 714). In some aspects, 804 may be performed by the beam refinement component 198.

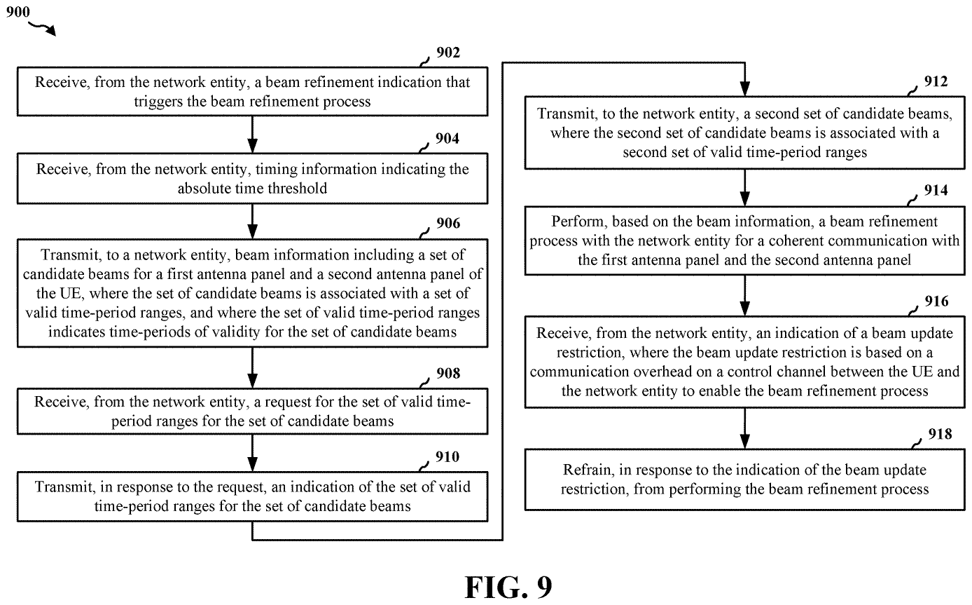

FIG. 9 is a flowchart 900 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 504, 604, 704; or the network entity 1202 in the hardware implementation of FIG. 12). The UE may be the UE 104, 350, 502, 602, 702, or the apparatus 1204 in the hardware implementation of FIG. 12. In some examples, the UE may have one or more antenna panels, such as antenna panel A 750, antenna panel B 752. At least one of these antenna panels (e.g., antenna panel A 750, antenna panel B 752) may be a mechanically displaceable panel. By introducing a network-configured “sticky” beam (or candidate beam) framework and enabling the network to request and manage time-validity information for the sticky beams, the methods reduce the overhead in beam update or beam refinement processes for devices using mechanically moveable antenna panels. Additionally, by enabling network-controlled timers for triggering (or retriggering) beam refinement based on factors such as motor speed, coherence, or signal quality, the methods can be used to adaptively maintain beam alignment under changing environmental or geometrical conditions, thereby reducing unnecessary overhead and improving user experience. In some examples, by allowing the network to place restrictions on beam update and beam refinement processes based on control channel overhead, the methods can be used to balance performance gains with signaling load, thereby maintaining reliable wireless communication.

As shown in FIG. 9, at 906, the UE may transmit to a network entity beam information including a set of candidate beams for a first antenna panel and a second antenna panel of the UE. The set of candidate beams may be associated with a set of valid time-period ranges, and the set of valid time-period ranges indicates time-periods of validity for the set of candidate beams. FIG. 5, FIG. 6, and FIG. 7 illustrate various aspects of the steps in connection with flowchart 900. For example, referring to FIG. 7, the UE 702 may, at 714, transmit to a network entity (e.g., base station 704) beam information including a set of candidate beams for a first antenna panel (e.g., antenna panel A 750) and a second antenna panel (e.g., antenna panel B 752) of the UE 702. The set of candidate beams may be associated with a set of valid time-period ranges, and the set of valid time-period ranges indicates time-periods of validity for the set of candidate beams. In some aspects, 906 may be performed by the beam refinement component 198.

At 914, the UE may perform, based on the beam information, a beam refinement process with the network entity for coherent communication with the first antenna panel and the second antenna panel. For example, referring to FIG. 7, the UE 702 may, at 722, perform a beam refinement process with the network entity (e.g., base station 704) for coherent communication with the first antenna panel (e.g., antenna panel A 750) and the second antenna panel (e.g., antenna panel B 752) based on the beam information (e.g., at 714). In some aspects, 914 may be performed by the beam refinement component 198.

In some aspects, at least one of the first antenna panel and the second antenna panel is a mechanically displaceable panel. For example, referring to FIG. 6, at least one of the first antenna panel and the second antenna panel (e.g., antenna panel 610) is a mechanically displaceable panel.

In some aspects, at 908, the UE may receive, from the network entity, a request for the set of valid time-period ranges for the set of candidate beams. For example, referring to FIG. 7, the UE 702 may, at 716, receive, from the network entity (e.g., base station 704), a request for the set of valid time-period ranges for the set of candidate beams. In some aspects, 908 may be performed by the beam refinement component 198.

In some aspects, at 910, the UE may transmit, in response to the request, an indication of the set of valid time-period ranges for the set of candidate beams. For example, referring to FIG. 7, the UE 702 may, at 710, transmit, in response to the request, an indication of the set of valid time-period ranges for the set of candidate beams. In some aspects, 910 may be performed by the beam refinement component 198.

In some aspects, the set of candidate beams may be a first set of candidate beams, and the set of valid time-period ranges may be a first set of valid time-period ranges, and at 912, the UE may transmit to the network entity a second set of candidate beams. The second set of candidate beams may be associated with a second set of valid time-period ranges, and the second set of valid time-period ranges occurs later than the first set of valid time-period ranges. For example, referring to FIG. 6, the set of candidate beams (e.g., the set of sticky beams 622) may be a first set of candidate beams, and the set of valid time-period ranges may be a first set of valid time-period ranges. For example, the first set of candidate beams (e.g., the set of sticky beams 622) may correspond to the original position 612 of antenna panel 610. Referring to FIG. 7, at 720, the UE 702 may transmit to the network entity (e.g., base station 704) a second set of candidate beams (e.g., the set of sticky beams 624). For example, the second set of candidate beams (the set of sticky beams 624) may correspond to the new position 614 of antenna panel 610. The second set of candidate beams (e.g., the set of sticky beams 624) may be associated with a second set of valid time-period ranges, and the second set of valid time-period ranges occurs later than the first set of valid time-period ranges. In some aspects, 912 may be performed by the beam refinement component 198.

In some aspects, the beam information (e.g., at 906) may further include the set of valid time-period ranges associated with the set of candidate beams. For example, referring to FIG. 7, the beam information (e.g., at 714) may further include the set of valid time-period ranges associated with the set of candidate beams.

In some aspects, at 902, the UE may receive from the network entity a beam refinement indication that triggers the beam refinement process, and the beam refinement indication may be based on an expiry of a timer. The UE may perform the beam refinement process (e.g., at 914) in response to the beam refinement indication. For example, referring to FIG. 7, the UE 702 may, at 710, receive from the network entity (e.g., base station 704) a beam refinement indication that triggers the beam refinement process (e.g., at 722), and the beam refinement indication may be based on an expiry of a timer. The UE 702 may, at 722, perform the beam refinement process in response to the beam refinement indication. In some aspects, 914 may be performed by the beam refinement component 198.

In some aspects, the expiry of the timer may be based on an absolute time threshold. For example, referring to FIG. 7, the expiry of the timer (that triggers the beam refinement indication at 710) may be based on an absolute time threshold.

In some aspects, at 904, the UE may receive from the network entity timing information indicating the absolute time threshold. For example, referring to FIG. 7, the UE 702 may, at 712, receive from the network entity (e.g., base station 704) timing information indicating the absolute time threshold. In some aspects, 904 may be performed by the beam refinement component 198.

In some aspects, the expiry of the timer may be associated with the speed of the mechanically displaceable panel. For example, referring to FIG. 7, the expiry of the timer (that triggers the beam refinement indication at 710) may be associated with the speed of the mechanically displaceable panel. Referring to FIG. 6, the expiry of the timer (that triggers the beam refinement indication at 710) may be associated with the speed of the mechanically displaceable antenna panel 610.

In some aspects, the expiry of the timer may be based on the beam coherence time estimation for beams associated with the first antenna panel or the second antenna panel at a prior time that is before the expiry of the timer. For example, referring to FIG. 7, the expiry of the timer (that triggers the beam refinement indication at 710) may be based on the beam coherence time estimation for beams associated with the first antenna panel (e.g., antenna panel 1 512) or the second antenna panel (e.g., antenna panel 2 514) at a prior time that is before the expiry of the timer.

In some aspects, the expiry of the timer may be based on a quality metric for communication between the UE and the network entity. For example, referring to FIG. 7, the expiry of the timer (that triggers the beam refinement indication at 710) may be based on a quality metric for communication between the UE 702 and the network entity (e.g., base station 704).

In some aspects, the quality metric may include one or more of: the RSRP of a signal between the UE and the network entity, or the change of the strength of the signal between the UE and the network entity. For example, referring to FIG. 7, the quality metric may include one or more of: the RSRP of a signal between the UE 702 and the network entity (e.g., base station 704) or the change of the strength of the signal between the UE 702 and the network entity (e.g., base station 704).

In some aspects, at 916, the UE may receive from the network entity an indication of a beam update restriction. The beam update restriction may be based on the communication overhead on the control channel between the UE and the network entity to enable the beam refinement process. At 918, the UE may refrain from performing the beam refinement process in response to the indication of the beam update restriction. For example, referring to FIG. 7, the UE 702 may, at 724, receive from the network entity (e.g., base station 704) an indication of a beam update restriction. The beam update restriction may be based on the communication overhead on the control channel between the UE 702 and the network entity (e.g., base station 704) to enable the beam refinement process. At 728, the UE 702 may refrain from performing the beam refinement process in response to the indication of the beam update restriction. In some aspects, 916 and 918 may be performed by the beam refinement component 198.

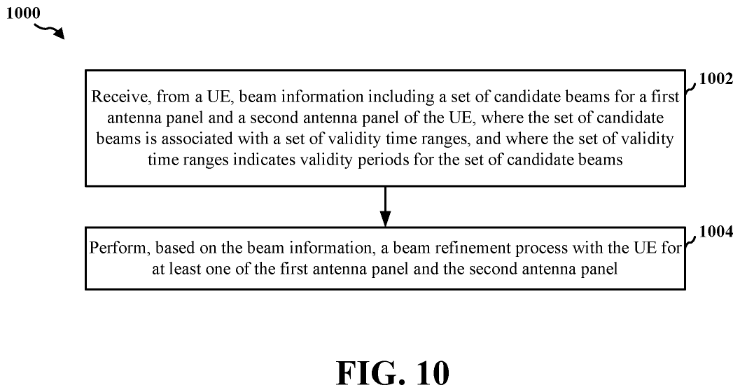

FIG. 10 is a flowchart 1000 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 504, 604, 704; or the network entity 1202 in the hardware implementation of FIG. 12). The UE may be the UE 104, 350, 502, 602, 702, or the apparatus 1204 in the hardware implementation of FIG. 12. In some examples, the UE may have one or more antenna panels, such as antenna panel A 750, antenna panel B 752. At least one of these antenna panels (e.g., antenna panel A 750, antenna panel B 752) may be a mechanically displaceable panel. By introducing a network-configured “sticky” beam (or candidate beam) framework and enabling the network to request and manage time-validity information for the sticky beams, the methods reduce the overhead in beam update or beam refinement processes for devices using mechanically moveable antenna panels. Additionally, by enabling network-controlled timers for triggering (or retriggering) beam refinement based on factors such as motor speed, coherence, or signal quality, the methods can be used to adaptively maintain beam alignment under changing environmental or geometrical conditions, thereby reducing unnecessary overhead and improving user experience. In some examples, by allowing the network to place restrictions on beam update and beam refinement processes based on control channel overhead, the methods can be used to balance performance gains with signaling load, thereby maintaining reliable wireless communication.

As shown in FIG. 10, at 1002, the network entity may receive from a UE, beam information including a set of candidate beams for a first antenna panel and a second antenna panel of the UE. The set of candidate beams may be associated with a set of validity time ranges, and the set of validity time ranges may indicate validity periods for the set of candidate beams. FIG. 5, FIG. 6, and FIG. 7 illustrate various aspects of the steps in connection with flowchart 1000. For example, referring to FIG. 7, the network entity (e.g., base station 704) may, at 714, receive from a UE 702, beam information including a set of candidate beams for a first antenna panel and a second antenna panel of the UE 702. The set of candidate beams may be associated with a set of validity time ranges, and the set of validity time ranges may indicate validity periods for the set of candidate beams. In some aspects, 1002 may be performed by the beam refinement component 199.

At 1004, the network entity may perform a beam refinement process with the UE for at least one of the first antenna panel and the second antenna panel based on the beam information. For example, referring to FIG. 7, the network entity (e.g., base station 704) may, at 722, perform a beam refinement process with the UE 702 for at least one of the first antenna panel (e.g., antenna panel A 750) and the second antenna panel (e.g., antenna panel B 752) based on the beam information. In some aspects, 1004 may be performed by the beam refinement component 199.

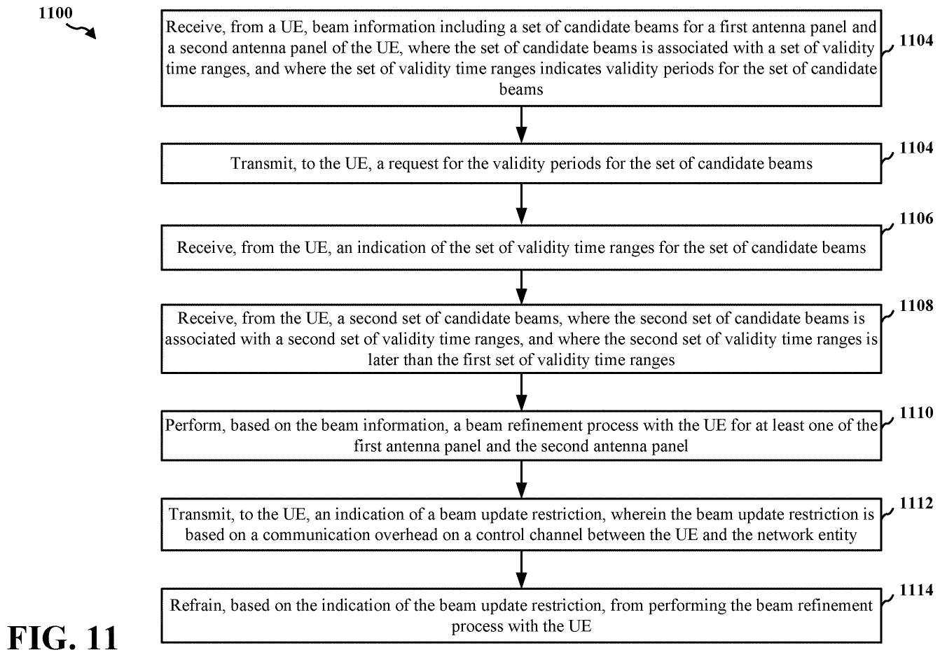

FIG. 11 is a flowchart 1100 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 504, 604, 704; or the network entity 1202 in the hardware implementation of FIG. 12). The UE may be the UE 104, 350, 502, 602, 702, or the apparatus 1204 in the hardware implementation of FIG. 12. In some examples, the UE may have one or more antenna panels, such as antenna panel A 750, antenna panel B 752. At least one of these antenna panels (e.g., antenna panel A 750, antenna panel B 752) may be a mechanically displaceable panel. By introducing a network-configured “sticky” beam (or candidate beam) framework and enabling the network to request and manage time-validity information for the sticky beams, the methods reduce the overhead in beam update or beam refinement processes for devices using mechanically moveable antenna panels. Additionally, by enabling network-controlled timers for triggering (or retriggering) beam refinement based on factors such as motor speed, coherence, or signal quality, the methods can be used to adaptively maintain beam alignment under changing environmental or geometrical conditions, thereby reducing unnecessary overhead and improving user experience. In some examples, by allowing the network to place restrictions on beam update and beam refinement processes based on control channel overhead, the methods can be used to balance performance gains with signaling load, thereby maintaining reliable wireless communication.

As shown in FIG. 11, at 1102, the network entity may receive from a UE, beam information including a set of candidate beams for a first antenna panel and a second antenna panel of the UE. The set of candidate beams may be associated with a set of validity time ranges, and the set of validity time ranges may indicate validity periods for the set of candidate beams. FIG. 5, FIG. 6, and FIG. 7 illustrate various aspects of the steps in connection with flowchart 1100. For example, referring to FIG. 7, the network entity (e.g., base station 704) may, at 714, receive from a UE 702, beam information including a set of candidate beams for a first antenna panel and a second antenna panel of the UE 702. The set of candidate beams may be associated with a set of validity time ranges, and the set of validity time ranges may indicate validity periods for the set of candidate beams. In some aspects, 1102 may be performed by the beam refinement component 199.

At 1110, the network entity may perform a beam refinement process with the UE for at least one of the first antenna panel and the second antenna panel based on the beam information. For example, referring to FIG. 7, the network entity (e.g., base station 704) may, at 722, perform a beam refinement process with the UE 702 for at least one of the first antenna panel (e.g., antenna panel A 750) and the second antenna panel (e.g., antenna panel B 752) based on the beam information. In some aspects, 1110 may be performed by the beam refinement component 199.

In some aspects, at least one of the first antenna panel and the second antenna panel is a mechanically displaceable panel. For example, referring to FIG. 6, at least one of the first antenna panel and the second antenna panel (e.g., antennal panel 610) is a mechanically displaceable panel.

In some aspects, at 1104, the network entity may transmit to the UE a request for the validity periods for the set of candidate beams. For example, referring to FIG. 7, the network entity (e.g., base station 704) may, at 716, transmit to the UE 702 a request for the validity periods for the set of candidate beams. In some aspects, 1104 may be performed by the beam refinement component 199.

In some aspects, at 1106, the network entity may receive from the UE an indication of the set of validity time ranges for the set of candidate beams. For example, referring to FIG. 7, the network entity (e.g., base station 704) may, at 718, receive from the UE 702 an indication of the set of validity time ranges for the set of candidate beams. In some aspects, 1106 may be performed by the beam refinement component 199.

In some aspects, the set of candidate beams may be a first set of candidate beams, and the set of validity time ranges may be a first set of validity time ranges, and at 1108, the network entity may receive from the UE a second set of candidate beams. The second set of candidate beams may be associated with a second set of validity time ranges, and the second set of validity time ranges is later than the first set of validity time ranges. For example, referring to FIG. 6, the set of candidate beams (e.g., the set of sticky beams 622) may be a first set of candidate beams, and the set of valid time-period ranges may be a first set of valid time-period ranges. For example, the first set of candidate beams (e.g., the set of sticky beams 622) may correspond to the original position 612 of antenna panel 610. Referring to FIG. 7, at 720, the network entity (e.g., base station 704) may receive from the UE 702 a second set of candidate beams (e.g., the set of sticky beams 624). For example, the second set of candidate beams (the set of sticky beams 624) may correspond to the new position 614 of antenna panel 610. The second set of candidate beams (e.g., the set of sticky beams 624) may be associated with a second set of valid time-period ranges, and the second set of valid time-period ranges occurs later than the first set of valid time-period ranges. In some aspects, 1108 may be performed by the beam refinement component 199.

In some aspects, the beam information may further include the set of validity time ranges associated with the set of candidate beams. For example, referring to FIG. 7, the beam information (e.g., at 714) may further include the set of valid time-period ranges associated with the set of candidate beams.

In some aspects, at 1112, the network entity may transmit to the UE an indication of a beam update restriction. The beam update restriction may be based on the communication overhead on the control channel between the UE and the network entity. At 1114, the network entity may refrain from performing the beam refinement process with the UE based on the indication of the beam update restriction. For example, referring to FIG. 7, the network entity (e.g., base station 704) may, at 724, transmit to the UE 702 an indication of a beam update restriction. The beam update restriction may be based on the communication overhead on the control channel between the UE 702 and the network entity (e.g., base station 704). At 726, the network entity (e.g., base station 704) may refrain from performing the beam refinement process with the UE based on the indication of the beam update restriction. In some aspects, 1112 and 1114 may be performed by the beam refinement component 199.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor (or processing circuitry) 1224 (also referred to as a modem) coupled to one or more transceivers 1222 (e.g., cellular RF transceiver). The cellular baseband processor(s) (or processing circuitry) 1224 may include at least one on-chip memory (or memory circuitry) 1224′. In some aspects, the apparatus 1204 may further include one or more subscriber identity modules (SIM) cards 1220 and at least one application processor (or processing circuitry) 1206 coupled to a secure digital (SD) card 1208 and a screen 1210. The application processor(s) (or processing circuitry) 1206 may include on-chip memory (or memory circuitry) 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) (or processing circuitry) 1224 communicates through the transceiver(s) 1222 via one or more antennas 1280 with the UE 104 and/or with an RU associated with a network entity 1202. The cellular baseband processor(s) (or processing circuitry) 1224 and the application processor(s) (or processing circuitry) 1206 may each include a computer-readable medium/memory (or memory circuitry) 1224′, 1206′, respectively. The additional memory modules 1226 may also be considered a computer-readable medium/memory (or memory circuitry). Each computer-readable medium/memory (or memory circuitry) 1224′, 1206′, 1226 may be non-transitory. The cellular baseband processor(s) (or processing circuitry) 1224 and the application processor(s) (or processing circuitry) 1206 are each responsible for general processing, including the execution of software stored on the computer-readable medium/memory (or memory circuitry). The software, when executed by the cellular baseband processor(s) (or processing circuitry) 1224/application processor(s) (or processing circuitry) 1206, causes the cellular baseband processor(s) (or processing circuitry) 1224/application processor(s) (or processing circuitry) 1206 to perform the various functions described supra. The cellular baseband processor(s) (or processing circuitry) 1224 and the application processor(s) (or processing circuitry) 1206 are configured to perform the various functions described supra based at least in part of the information stored in the memory (or memory circuitry). That is, the cellular baseband processor(s) (or processing circuitry) 1224 and the application processor(s) (or processing circuitry) 1206 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1224/application processor(s) (or processing circuitry) 1206 when executing software. The cellular baseband processor(s) (or processing circuitry) 1224/application processor(s) (or processing circuitry) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) (or processing circuitry) 1224 and/or the application processor(s) (or processing circuitry) 1206, and in another configuration, the apparatus 1204 may be the entire UE (e.g., see UE 350 of FIG. 3) and include the additional modules of the apparatus 1204.

As discussed supra, the component 198 may be configured to transmit, to a network entity, beam information including a set of candidate beams for a first antenna panel and a second antenna panel of the UE, where the set of candidate beams is associated with a set of valid time-period ranges, and where the set of valid time-period ranges indicates time-periods of validity for the set of candidate beams; and perform, based on the beam information, a beam refinement process with the network entity for coherent communication with the first antenna panel and the second antenna panel. The component 198 may be further configured to perform any of the aspects described in connection with the flowcharts in FIG. 8 and FIG. 9, and/or performed by the UE 702 in FIG. 7. The component 198 may be within the cellular baseband processor(s) (or processing circuitry) 1224, the application processor(s) (or processing circuitry) 1206, or both the cellular baseband processor(s) (or processing circuitry) 1224 and the application processor(s) (or processing circuitry) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) (or processing circuitry) 1224 and/or the application processor(s) (or processing circuitry) 1206, includes means for transmitting, to a network entity, beam information including a set of candidate beams for a first antenna panel and a second antenna panel of the UE, where the set of candidate beams is associated with a set of valid time-period ranges, and where the set of valid time-period ranges indicates time-periods of validity for the set of candidate beams; and means for performing, based on the beam information, a beam refinement process with the network entity for coherent communication with the first antenna panel and the second antenna panel. The apparatus 1204 may further include means for performing any of the aspects described in connection with the flowcharts in FIG. 8 and FIG. 9, and/or aspects performed by the UE 702 in FIG. 7. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

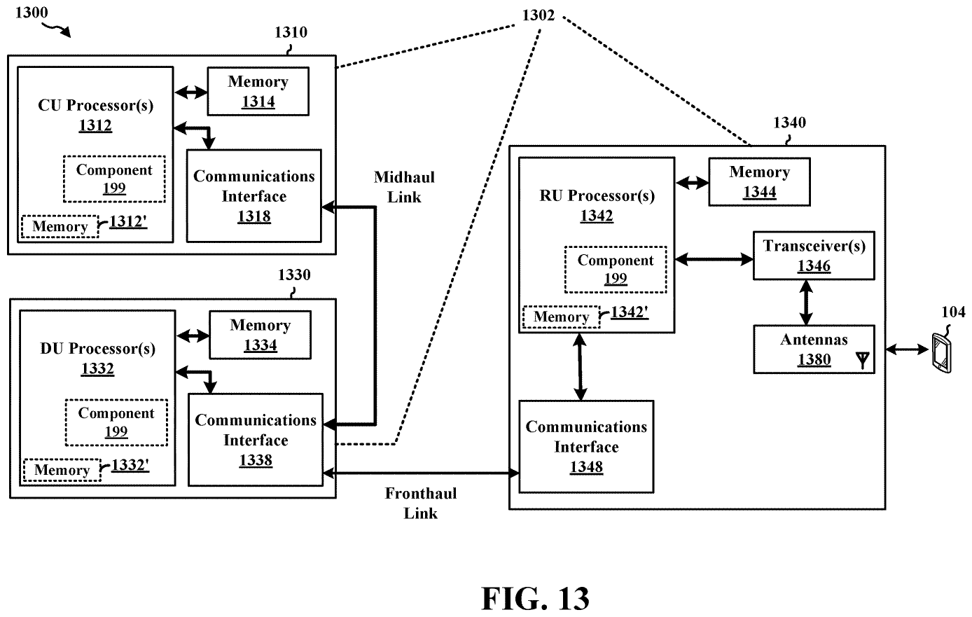

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor (or processing circuitry) 1312. The CU processor(s) (or processing circuitry) 1312 may include on-chip memory (or memory circuitry) 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor (or processing circuitry) 1332. The DU processor(s) (or processing circuitry) 1332 may include on-chip memory (or memory circuitry) 1332′. In some aspects, the DU 1330 may further include additional memory modules 1334 and a communications interface 1338. The DU 1330 communicates with the RU 1340 through a fronthaul link. The RU 1340 may include at least one RU processor (or processing circuitry) 1342. The RU processor(s) (or processing circuitry) 1342 may include on-chip memory (or memory circuitry) 1342′. In some aspects, the RU 1340 may further include additional memory modules 1344, one or more transceivers 1346, antennas 1380, and a communications interface 1348. The RU 1340 communicates with the UE 104. The on-chip memory (or memory circuitry) 1312′, 1332′, 1342′ and the additional memory modules 1314, 1334, 1344 may each be considered a computer-readable medium/memory (or memory circuitry). Each computer-readable medium/memory (or memory circuitry) may be non-transitory. Each of the processors (or processing circuitry) 1312, 1332, 1342 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a UE, beam information including a set of candidate beams for a first antenna panel and a second antenna panel of the UE, where the set of candidate beams is associated with a set of validity time ranges, and where the set of validity time ranges indicates validity periods for the set of candidate beams; and perform, based on the beam information, a beam refinement process with the UE for at least one of the first antenna panel and the second antenna panel. The component 199 may be further configured to perform any of the aspects described in connection with the flowcharts in FIG. 10 and FIG. 11, and/or performed by the base station 704 in FIG. 7. The component 199 may be within one or more processors (or processing circuitry) of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 includes means for receiving, from a UE, beam information including a set of candidate beams for a first antenna panel and a second antenna panel of the UE, where the set of candidate beams is associated with a set of validity time ranges, and where the set of validity time ranges indicates validity periods for the set of candidate beams; and means for performing, based on the beam information, a beam refinement process with the UE for at least one of the first antenna panel and the second antenna panel. The network entity 1302 may further include means for performing any of the aspects described in connection with the flowcharts in FIG. 10 and FIG. 11, and/or aspects performed by the base station 704 in FIG. 7. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include transmitting, to a network entity, beam information including a set of candidate beams for a first antenna panel and a second antenna panel of the UE, where the set of candidate beams is associated with a set of valid time-period ranges, and where the set of valid time-period ranges indicates time-periods of validity for the set of candidate beams; and performing, based on the beam information, a beam refinement process with the network entity for coherent communication with the first antenna panel and the second antenna panel. By introducing a network-configured “sticky” beam (or candidate beam) framework and enabling the network to request and manage time-validity information for the sticky beams, the methods reduce the overhead in beam update or beam refinement processes for devices using mechanically moveable antenna panels. Additionally, by enabling network-controlled timers for triggering (or retriggering) beam refinement based on factors such as motor speed, coherence, or signal quality, the methods can be used to adaptively maintain beam alignment under changing environmental or geometrical conditions, thereby reducing unnecessary overhead and improving user experience. In some examples, by allowing the network to place restrictions on beam update and beam refinement processes based on control channel overhead, the methods can be used to balance performance gains with signaling load, thereby maintaining reliable wireless communication.

Some wireless communications systems may include a UE, such as a customer premises equipment (CPE). A CPE may include telecommunications and/or information technology equipment that operates at a customer's or user's physical location rather than at a location of the service provider. A CPE can provide an alternate mechanism to provide fixed wireless access (FWA) facilities at a customer's premises. In some examples, a CPE may include a millimeter wave (mmW) device for operations in mmW frequency bands. A CPE may include a set of at least one antenna array or antenna panel that includes an antenna array. Some CPEs include large antenna arrays (for example, 8×8 dual-polarized antenna arrays, 16×8 dual-polarized antenna arrays, and/or 16×16 dual-polarized antenna arrays), which may cost more than smaller antenna arrays. These antenna elements can be dual-polarized providing a doubling of the rate of communication via polarization-based communications for the same area on the chip/real-estate. As demand for lower-cost implementations for CPEs increases, CPEs may be implemented with multiple smaller antenna arrays rather than a single larger antenna array. Some CPEs may include a reflector and/or a mechanical rotator corresponding to each antenna panel, which may support communication parameters, such as effective isotropic radiated power (EIRP) and array gain, without the use of large antenna arrays. Smaller antenna arrays supported by a reflector and/or a mechanical rotator may also support lower power consumption, lower thermal overhead associated with CPE/antenna array operations, and overall lower cost of the materials used to manufacture the CPE.

CPEs are commonly used in wireless communication systems to provide connectivity to end users, such as in residential or business environments. These devices are often deployed to facilitate communication with network nodes within cellular networks or to replace traditional Wi-Fi systems, particularly in scenarios where high-frequency millimeter wave bands, such as 28 GHz, are required to support reliable coverage and high data rates. Conventional CPEs often employ large antenna arrays, such as 8×8 dual-polarized antenna arrays, 16×8 dual-polarized antenna arrays, and/or 16×16 dual-polarized antenna arrays, to achieve high array gain, maintain signal quality, and overcome propagation losses caused by physical obstructions, such as concrete walls or metallic fixtures. However, the use of large antenna arrays increases the cost, complexity, and power consumption of these devices, which can make them less suitable for price-sensitive or low-cost markets.

While mechanically steerable antenna panels offer advantages in terms of cost and flexibility, they introduce several technical challenges. First, the movement of these panels is inherently slow compared to the time-scale at which wireless communications operations are performed (e.g., symbol periods). Mechanical displacement can take seconds or even tens of seconds to complete, whereas symbol periods are typically measured in nanoseconds or microseconds. This orders-of-magnitude disparity can lead to communication disruptions and degraded performance during the displacement process, as the antenna panel may not be available for signal transmission or reception while the antenna panel is being repositioned.

When antenna panels are moved to new positions, the alignment of beams across multiple panels becomes critical for maintaining coherent communication. Coordinated transmission or reception across multiple panels can improve signal-to-noise ratio (SNR), particularly in cell-edge scenarios. However, achieving coherent communication requires careful beam management and enhancement, including the selection of appropriate beams and the determination of co-phasing factors to align signals from multiple panels. Incorrect beam alignment or co-phasing can result in increased inter-beam interference, degraded SNR, and reduced communication performance.

Some beam management approaches involve extensive beam training and feedback between the CPE and the network node. These methods typically require the CPE to provide feedback on potential beam combinations, which the network node uses to transmit reference signals for beam refinement and selection. However, this process can result in significant network overhead, particularly when the mechanical displacement of panels leads to frequent beam re-training. Additionally, the feedback and refinement process may be resource-intensive when the quantity of potential beam combinations is large, further straining network resources.

The dynamic nature of mechanical displacement introduces variability in the local geometry and channel environment, which can affect the efficacy of previously trained beams. For example, temporary obstructions or changes in the orientation of panels may degrade the performance of previously selected beams. Without an efficient mechanism to adapt to these changes, the CPE may experience degraded communication quality, reduced data rates, and increased latency.

Overall, the use of mechanically steerable antenna panels in low-cost CPE implementations raises challenges related to slow panel movements, coordinated beam management, network overhead, and dynamic environmental changes. These challenges highlight the need for improved techniques to enable efficient beam management, reduce network overhead, and maintain high communication performance despite the inherent limitations of mechanical displacement mechanisms.

Various aspects relate generally to enhancing beam management and reducing network overhead for wireless communication systems with mechanically displaceable antenna panels. Some aspects more specifically relate to enabling a wireless communication device (e.g., a CPE) to perform coordinated communication across multiple antenna panels with reduced beam refinement overhead. In some aspects, the wireless communication device may perform mechanical displacement of an antenna panel from one location to another and refine a communication beam steering direction correlated to previously selected beams according to a local coordinate system of the device. The device may communicate with a network node using a second communication beam associated with the displaced antenna panel in coordination with a third communication beam associated with another antenna panel. This coordinated communication may leverage the notion of a “sticky beam” set of pre-selected beams stored in a codebook, reducing the need for extensive beam re-training and feedback. In a “sticky beam” set, the set of beams used for beam refinement remain the same whereas the co-phasing factor search is coordinated by the network entity (e.g., via a beam management procedure) for speedier beam management.

In some aspects, the wireless communication device may transmit signaling to the network node, such as an indication of mechanical displacement, an indication of the sticky beam set, or an indication to retrigger beam refinement based on changes in the geometry of the antenna modules within the device, or perceived/observed channel quality. The device may also select the set of co-phasing factors for coordinated communication across multiple panels and transmit these factors to the network node. In some aspects, the network node may assist beam refinement by transmitting reference signals associated with the set of co-phasing factors and beam refinement parameters, enabling the wireless communication device to enhance beam selection and alignment for coordinated transmission or reception by appropriate selection of the co-phasing factor to be used at the device.

Particular aspects of the subject matter described in this disclosure can be implemented to realize one or more of the following potential advantages. In some examples, by using sticky beam sets and correlating steering directions based on the local coordinate system, the described techniques can reduce network overhead associated with beam training and feedback, particularly for CPEs with mechanically displaceable panels. For example, the wireless communication device can leverage prior information of beam steering directions and pre-determined beams stored in codebooks to accelerate beam selection following mechanical displacement. This reduces the need for a full-blown/complete beam re-training, thus conserving network resources, processing resources, and/or memory resources.

In some aspects, by transmitting signaling such as sticky beam indications or retrigger signals, the wireless communication device can adapt to dynamic changes such as temporary obstructions or degraded channel conditions. This signaling enables the network node to coordinate communications efficiently by reducing inter-beam interference, minimizing processing effort for beam refinement, and enhancing SNR at cell edge scenarios. Additionally, by enabling the network node to assist in beam refinement through reference signal allocation and co-phasing factor search, the system reduces the computational burden on the wireless communication device, further conserving processing resources while maintaining robust communication performance.

The described techniques may also address technical challenges associated with mechanically displaceable antenna panels, such as slow mechanical movements and dynamic environmental changes, while maintaining high data rates and reliable coverage. By leveraging coordinated signaling, sticky beam sets, and network-assisted refinement, the system can enable efficient communication operations even under varying mechanical and environmental conditions. As a result, the techniques may conserve network resources, processing resources, and/or memory resources, supporting the deployment of cost-efficient yet technically robust communication systems suitable for high-density environments and emerging applications of millimeter wave technologies.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

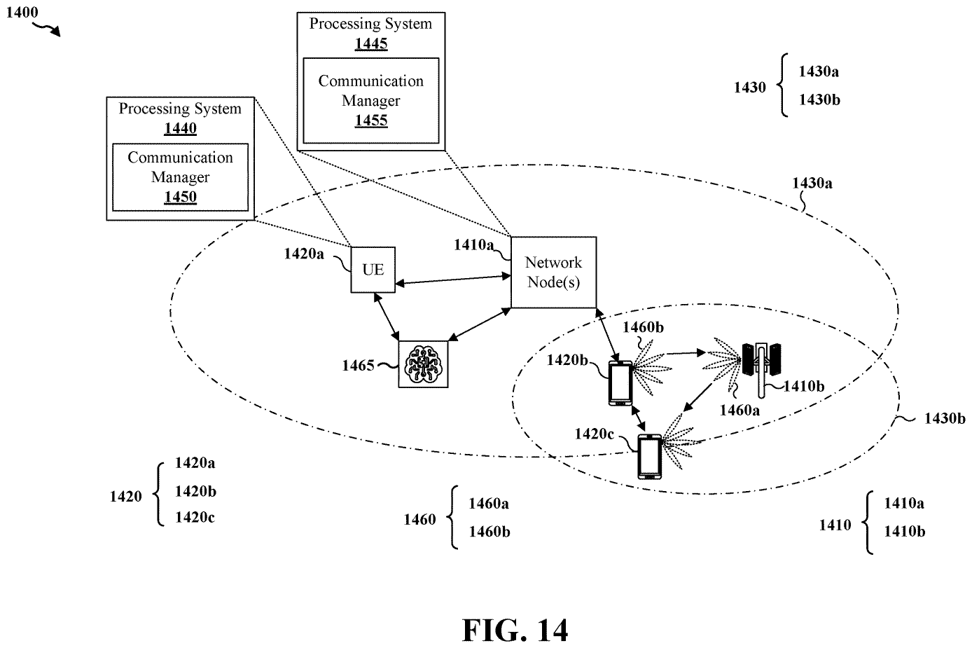

FIG. 14 is a diagram illustrating an example of a wireless communication network 1400. The wireless communication network 1400 may be or may include elements of a 5G network or a 6G network, among other examples. The wireless communication network 1400 may include multiple network nodes 1410. For example, in FIG. 14, the wireless communication network 1400 includes multiple network nodes 1410, including a network node 1410a and a network node 1410b (each of which also may be referred to herein simply as a “network node 1410”). The network nodes 1410 may support communications with multiple UEs 1420. For example, in FIG. 14, the network nodes 1410 support communication with a UE 1420a, a UE 1420b, and a UE 1420c (each of which also may be referred to herein simply as a “UE 1420”). In some examples, a UE 1420 also may communicate with other UEs 1420 and a network node 1410 also may communicate with a core network and with other network nodes 1410.

The network nodes 1410 and the UEs 1420 of the wireless communication network 1400 communicate using the electromagnetic spectrum, which may be subdivided into various licensed or unlicensed operating bands, frequency ranges, component carriers, or channels that define associated frequencies available for communications. In some examples, each of the network nodes 1410 and the UEs 1420 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 1410 or a UE 1420 may include one or more devices, components, or systems that enable communication with other devices, components, or systems of the wireless communication network 1400. For example, a UE 1420 and a network node 1410 may each include one or more chips, system-on-chips (SoCs), chipsets, packages, or devices that individually or collectively constitute or comprise a processing system. As shown in FIG. 14, each UE 1420 includes a processing system 1440 and each network node 1410 includes a processing system 1445. A processing system (for example, the processing system 1440 or the processing system 1445) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 1440 and the processing system 1445 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 1440 and the processing system 1445 may each include or be coupled with one or more modems (such as a cellular (for example, a 5G or 6G compliant) modem). In some examples, one or more processors of the processing system 1440 or the processing system 1445 may include or implement one or more of the modems. The processing system 1440 and the processing system 1445 also may include or be coupled with multiple radios (collectively “the radio”), multiple RF chains, or multiple transceivers, each of which may in turn be coupled with one or more of multiple antennas. In some examples, one or more processors of the processing system 1440 or the processing system 1445 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 1440 or by the processing system 1445).

A network node 1410 and a UE 1420 may each include one or multiple antennas or antenna arrays. Typical network nodes 1410 and UEs 1420 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 1410 and the UE 1420. A network node 1410 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 1410 may be implemented as a single physical node (for example, a single physical structure) or may be implemented as two or more physical nodes (for example, two or more distinct physical structures). For example, a network node 1410 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 1410 may be an aggregated network node having an aggregated architecture, meaning that the network node 1410 may implement a full radio protocol stack that is physically and logically integrated within a single physical structure in the wireless communication network 1400. For example, an aggregated network node 1410 may include a single standalone base station or a single TRP that operates with a full radio protocol stack to enable or facilitate communication between a UE 1420 and a core network of the wireless communication network 1400.

Alternatively, a network node 1410 may be a disaggregated network node 1410 (sometimes referred to as a disaggregated base station), having a disaggregated architecture, meaning that the network node 1410 may operate with a radio protocol stack that is physically distributed or logically distributed among two or more nodes in the same geographic location or in different geographic locations. In some deployments, disaggregated network nodes 1410 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 1410 of the wireless communication network 1400 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 1420. A CU may communicate with one or more DUs via respective midhaul links, such as via F1 interfaces. Each of the DUs may communicate with one or more RUs via respective fronthaul links. Each of the RUs may communicate with one or more UEs 1420 via respective RF access links. In some deployments, a UE 1420 may be simultaneously served by multiple RUs.

In some examples, a single network node 1410 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 1400 may be a heterogeneous network that includes network nodes 1410 of various types. Different types of network nodes 1410 may generally operate on the same or different operating bands, transmit at different power levels, or serve different coverage areas, each of which may be referred to as or associated with a particular cell 1430 (for example, a cell 1430a and a cell 1430b).

The UEs 1420 may be physically dispersed throughout the coverage area of the wireless communication network 1400, and each UE 1420 may be stationary or mobile. A UE 1420 may be, may include, or also may be referred to as an access terminal, a mobile station, a client device, or a subscriber unit. A UE 1420 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 1400.

Some UEs 1420 may be classified according to different categories in association with different complexities or different capabilities. UEs 1420 in a first category may be associated with relatively low complexity or cost such as NB-IoT devices or eMTC UEs. UEs 1420 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 1400. A third category of UEs 1420 may have mid-tier complexity or capabilities (for example, capabilities between that of the UEs 1420 of the first category and the UEs 1420 of the second category). A UE 1420 of the third category may be referred to as a reduced capability UE (“RedCap UE”), a mid-tier UE, an NR-Light UE, or an NR-Lite UE, among other examples.

In some examples, a network node 1410 may be, may include, or may operate as an RU, a TRP, or a base station that communicates with one or more UEs 1420 via a radio access link (which may be referred to as a “Uu” link). The radio access link may include a downlink and an uplink. “Downlink” (or “DL”) refers to a communication direction from a network node 1410 to a UE 1420, and “uplink” (or “UL”) refers to a communication direction from a UE 1420 to a network node 1410. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 1420 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 1410 transmitting a downlink control information (DCI) configuration to the one or more UEs 1420) or reconfigured (for example, in real-time or near-real-time) according to changing network conditions in the wireless communication network 1400 or specific requirements of one or more UEs 1420. An active BWP defines the operating bandwidth of the UE 1420 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 1410 to a UE 1420. DCI generally contains the information the UE 1420 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 1420) from a network node 1410 to a UE 1420. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 1420 to a network node 1410. An uplink data channel may be used to transmit uplink data (for example, user data associated with a UE 1420) from a UE 1420 to a network node 1410. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 1410), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 1410 to a UE 1420, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 1410 or UE 1420 over a wireless communication channel. In some examples, the network node 1410 or the UE 1420 (for example, using the processing system 1445 or the processing system 1440, respectively) may select an MCS (for example, an order of quadrature amplitude modulation (QAM), such as 64-QAM, 128-QAM, or 256-QAM, among other examples) for a downlink signal or an uplink signal. For example, the network node 1410 may select an MCS for a downlink signal in accordance with UCI received from the UE 1420 or may transmit, to the UE 1420, an indication of an MCS to be applied for an uplink signal.

A network node 1410 or a UE 1420 (such as by using the processing system 1445 or the processing system 1440, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 1410 or the UE 1420 (for example, using the processing system 1445 or the processing system 1440, respectively, or one or more coupled encoders or modems) may perform a channel coding operation or a forward error correction (FEC) operation to control errors in transmitted information. For example, the network node 1410 or the UE 1420 may perform an encoding operation to generate encoded information (such as by selectively introducing redundancy into the information, typically using an error correction code (ECC), such as a polar code or a low-density parity-check (LDPC) code). The network node 1410 or the UE 1420 (for example, using the processing system 1445 or one or more modems) may further perform spatial processing (for example, precoding) on the encoded information to generate one or more processed or precoded signals for downlink or uplink transmission, respectively. In some examples, the network node 1410a or the UE 1420a may perform codebook-based precoding or non-codebook-based precoding. Codebook-based precoding may involve selecting a precoder (for example, a precoding matrix) using a codebook. For example, the network node 1410a may provide precoding information indicating which precoder, defined by the codebook, is to be used by the UE 1420a. Non-codebook-based precoding may involve selecting or deriving a precoder based on, or otherwise associated with, one or more downlink or uplink signal measurements. The network node 1410a or the UE 1420a may transmit the processed downlink or uplink signals, respectively, via one or more antennas.

The network node 1410a or the UE 1420a may receive uplink signals or downlink signals, respectively, via one or more antennas. The network node 1410a or the UE 1420a (for example, using the processing system 1445 or the processing system 1440, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 1410 or the UE 1420 via the downlink or uplink signals. The network node 1410a or the UE 1420a (for example, using the processing system 1445 or the processing system 1440, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 1420 and a network node 1410 may perform MIMO communication. MIMO communication generally refers to transmitting or receiving multiple signals (such as multiple layers or multiple data streams) simultaneously over the same time and frequency resources. A network node 1410 or a UE 1420 may communicate using single-user MIMO or multi-user MIMO (MU-MIMO), the latter of which being used by a network node 1410 to simultaneously transmit signals to multiple UEs 1420. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 1410 may generate one or more beams 1460a, and a UE 1420 may generate one or more beams 1460b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 1410 or a UE 1420 may implement massive MIMO, which may be associated with an increased (for example, “massive”) quantity of antennas at the network node 1410 or at the UE 1420, such as in a network implementing mmWave technology, which enables more precise beamforming or reduced interference. In some examples, the wireless communication network 1400 may implement multi-TRP (mTRP) operation (including redundant transmission or reception on multiple TRPs) or non-coherent joint transmission (NC-JT).

The network node 1410 and the UE 1420 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 1410 transmitting signals (for example, SSBs or other signals) via respective beams (for example, of the beams 1460 of the network node 1410) and the UE 1420 receiving and measuring the signal(s) via respective beams of multiple beams (for example, from the beams 1460 of the UE 1420) to identify a best beam (or beam pair) for communication between the UE 1420 and the network node 1410. A beam refinement operation may involve a first device (for example, the UE 1420 or the network node 1410) transmitting signal(s) via a subset of beams (for example, identified based on, or otherwise associated with, measurements reported as part of one or more other beam management operations). A second device (for example, the network node 1410 or the UE 1420) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 1465 (for example, one or more network nodes 1410, one or more UEs 1420, one or more servers, or one or more components of a cloud computing network, among other examples). For example, in a deployment in which AI/ML functionality is performed independently at a device 1465, sometimes referred to as “overlay AI/ML,” the AI/ML model (or an instance or portion of the AI/ML model) may be deployed at a UE 1420 (for example, by the processing system 1440), a network node 1410 (for example, by the processing system 1445), one or more servers, or one or more components of a cloud computing network, among other examples. Additionally, or alternatively, in a deployment where AI/ML functionality is coordinated between different devices 1465, sometimes referred to as “coordinated AI/ML,” or performed at all device and network layers, sometimes referred to as “native AI/ML,” the AI/ML model (or an instance of the AI/ML model) may be deployed at multiple devices 1465 (for example, a first portion of the AI/ML model may be deployed at a UE 1420 and a second portion of the AI/ML model may be deployed at a network node 1410). In other examples of coordinated AI/ML or native AI/ML, a first AI/ML model may be deployed at a UE 1420 and a second AI/ML model may be deployed at a network node 1410. The AI/ML model(s) may be configured to enhance various aspects of the wireless communication network 1400 (for example, to increase privacy, reliability, or efficient use of network bandwidth, or to reduce latency, among other examples). For example, the AI/ML model(s) may be trained to identify patterns or relationships in data corresponding to the wireless communication network 1400, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 1420, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

Further efficiencies in throughput, signal strength, or other signal properties may be achieved through beam refinement. For example, the network node 1410 may be capable of communicating with the UE 1420 using beams (for example, beam(s) 1460a) of different beam widths. In some examples, the network node 1410 may be configured to utilize a wider beam to communicate with the UE 1420 when the UE 1420 is in motion or for initial beam acquisition because wider coverage may increase the likelihood that the mobile UE 1420 remains in coverage of the network node 1410 while communicating using the wider beam. Conversely, the network node 1410 may use a narrower beam to communicate with the UE 1420 when the UE 1420 is stationary because the network node 1410 can reliably focus coverage on the UE 1420 with low or minimal likelihood of the UE 1420 moving out of the coverage area of the narrower beam. In some examples, to select a particular beam (for example, from the beam(s) 1460a) for communication with a UE 1420, the network node 1410 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 1420 may measure the RSRP or the signal-to-interference-plus-noise ratio (SINR) on each of the beams and transmit a beam measurement report (for example, a Layer 1 (L1) measurement report) to the network node 1410 indicating the RSRP or SINR associated with each of one or more of the measured beams. The network node 1410 may then select the particular beam for communication with the UE 1420 based on the L1 measurement report. In some other examples, when there is channel reciprocity between the uplink and the downlink, the network node 1410 may derive the particular beam to communicate with the UE 1420 (for example, on both the uplink and downlink) based on uplink measurements of one or more uplink reference signals, such as an SRS, transmitted by the UE 1420.

In some aspects, the wireless communication device may be an example of a UE 1420 and may include a communication manager 1450. As described in more detail elsewhere herein, the communication manager 1450 may communicate, with a network node 1410 using a plurality of antenna panels including a first antenna panel at a first location, one or more messages via a first communication beam corresponding to a first beam steering direction; perform a mechanical displacement of the first antenna panel from the first location to a second location; perform a beam refinement procedure for the plurality of antenna panels including the first antenna panel at the second location to select a second communication beam in coordination with a third communication beam associated with a second antenna panel; and communicate, with the network node 1410 using the first antenna panel at the second location, one or more messages via the second communication beam corresponding to a second beam steering direction that is correlated to the first beam steering direction according to a local coordinate system of the wireless communication device. Additionally, or alternatively, the communication manager 1450 may perform one or more other operations described herein.

In some aspects, the network node 1410 may include a communication manager 1455. As described in more detail elsewhere herein, the communication manager 1455 may communicate, with a wireless communication device that is using a plurality of antenna panels including a first antenna panel at a first location, one or more messages via a first communication beam that corresponds to a first beam steering direction; perform, via one or more communications with the wireless communication device, a beam refinement procedure for communicating with the plurality of antenna panels including the first antenna panel at a second location to select a second communication beam in coordination with a third communication beam that is associated with a second antenna panel; and communicate, with the wireless communication device that is using the first antenna panel at the second location, one or more messages via the second communication beam corresponding to a second beam steering direction that is correlated to the first beam steering direction according to a local coordinate system of the wireless communication device. Additionally, or alternatively, the communication manager 1455 may perform one or more other operations described herein.

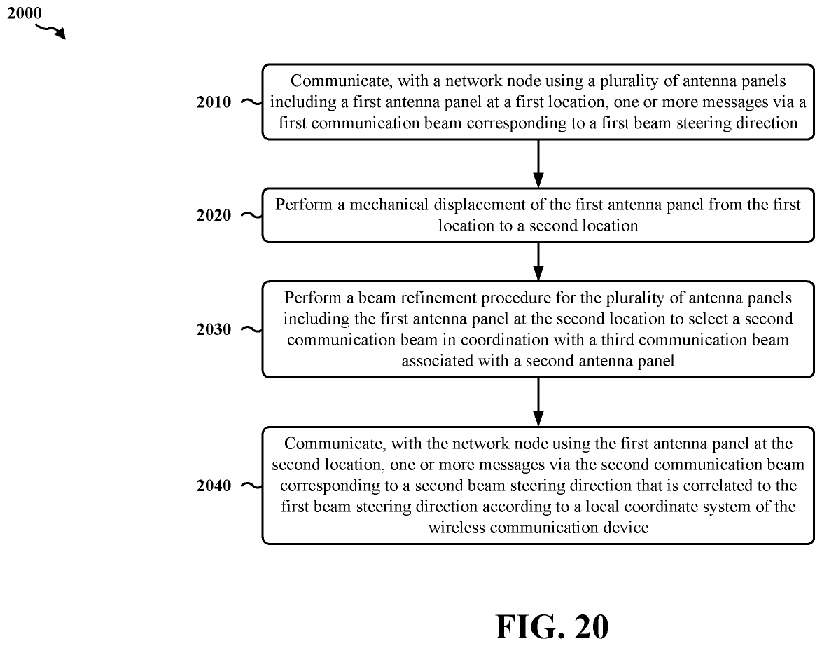

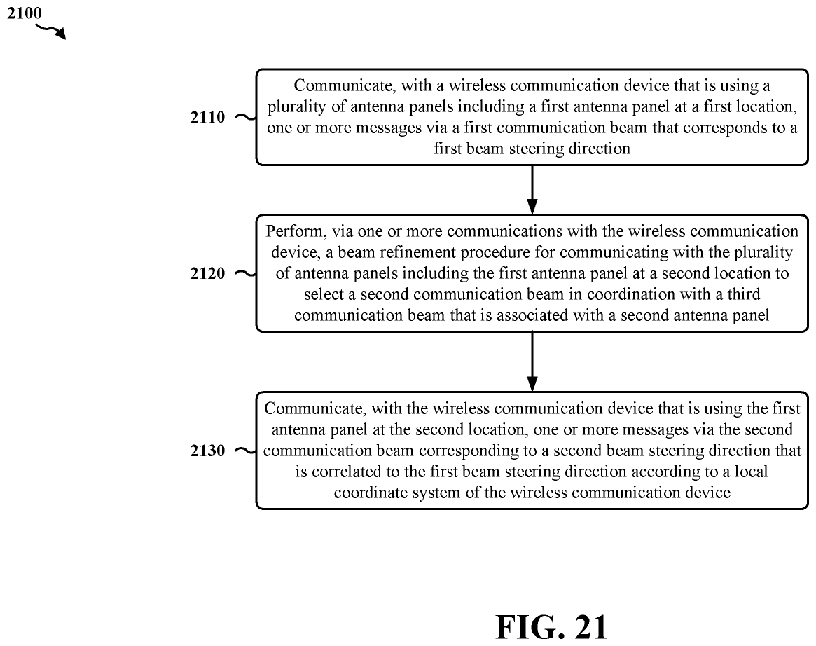

The network node 1410, the processing system 1445 of the network node 1410, the UE 1420, the processing system 1440 of the UE 1420, or any other component(s) of FIG. 14 may implement one or more techniques or perform one or more operations associated with semi-deterministic beam management in devices with moveable antenna panels, as described in more detail elsewhere herein. For example, the processing system 1445 of the network node 1410, or the processing system 1440 of the UE 1420 may perform or direct operations of, for example, process 2000 of FIG. 20, process 2100 of FIG. 21, or other processes as described herein (alone or in conjunction with one or more other processors). In some aspects, the wireless communication device described herein is a UE 1420, is an example of a UE 1420 including a CPE, is included in the UE 1420, or includes one or more components of the UE 1420 shown in FIG. 14. Memory of the network node 1410 may store data and program code (or instructions) for the network node 1410. In some examples, the memory of the network node 1410 may store data relating to a UE 1420, such as RRC state information or a UE context. Memory of a UE 1420 may store data and program code (or instructions) for the UE 1420, such as context information. In some examples, the memory of the UE 1420 or the memory of the network node 1410 may include a non-transitory computer-readable medium storing a set of instructions for wireless communication. For example, the set of instructions, when executed by one or more processors (for example, of the processing system 1445 or the processing system 1440) of the network node 1410, or the UE 1420, may cause the one or more processors to perform process 2000 of FIG. 20, process 2100 of FIG. 21, or other processes as described herein. In some examples, executing instructions may include running the instructions, converting the instructions, compiling the instructions, or interpreting the instructions, among other examples.

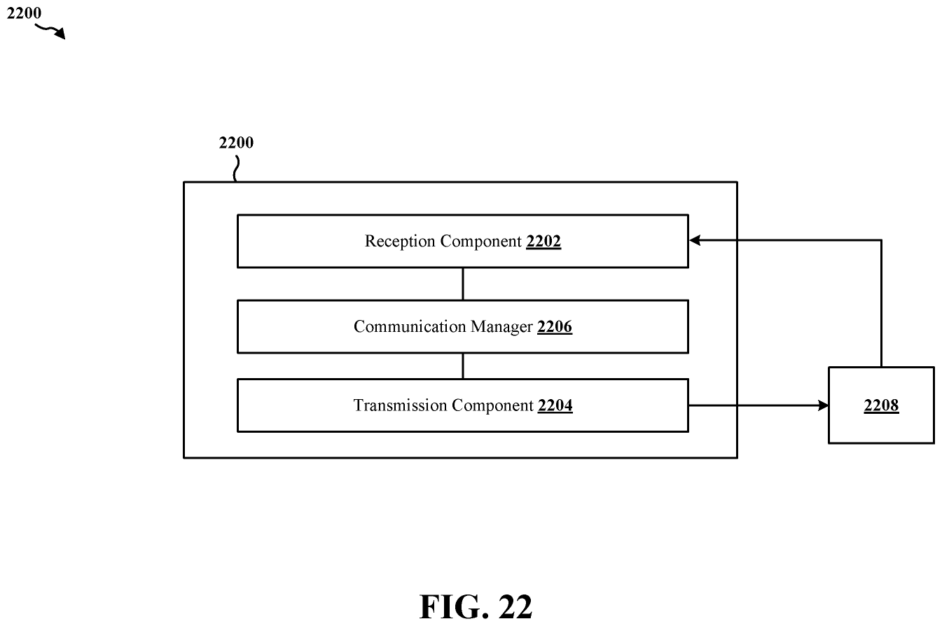

In some aspects, a wireless communication device includes means for communicating, with a network node using a plurality of antenna panels including a first antenna panel at a first location, one or more messages via a first communication beam corresponding to a first beam steering direction; means for performing a mechanical displacement of the first antenna panel from the first location to a second location; means for performing a beam refinement procedure for the plurality of antenna panels including the first antenna panel at the second location to select a second communication beam in coordination with a third communication beam associated with a second antenna panel; or means for communicating, with the network node using the first antenna panel at the second location, one or more messages via the second communication beam corresponding to a second beam steering direction that is correlated to the first beam steering direction according to a local coordinate system of the wireless communication device. In some aspects, the means for the wireless communication device to perform operations described herein may include, for example, one or more of communication manager 1450, processing system 1440, a radio, one or more RF chains, one or more transceivers, one or more antennas, one or more modems, a reception component (for example, reception component 2202 depicted and described in connection with FIG. 22), or a transmission component (for example, transmission component 2204 depicted and described in connection with FIG. 22), among other examples.

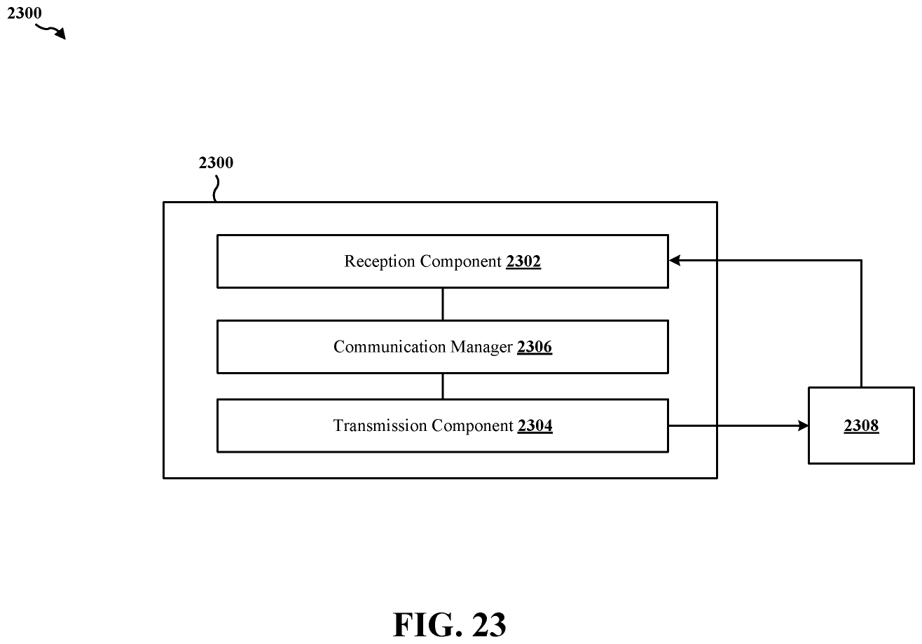

In some aspects, the network node 1410 includes means for communicating, with a wireless communication device that is using a plurality of antenna panels including a first antenna panel at a first location, one or more messages via a first communication beam that corresponds to a first beam steering direction; means for performing, via one or more communications with the wireless communication device, a beam refinement procedure for communicating with the plurality of antenna panels including the first antenna panel at a second location to select a second communication beam in coordination with a third communication beam that is associated with a second antenna panel; or means for communicating, with the wireless communication device that is using the first antenna panel at the second location, one or more messages via the second communication beam corresponding to a second beam steering direction that is correlated to the first beam steering direction according to a local coordinate system of the wireless communication device. The means for the network node 1410 to perform operations described herein may include, for example, one or more of communication manager 1455, processing system 1445, a radio, one or more RF chains, one or more transceivers, one or more antennas, one or more modems, a reception component (for example, reception component 2302 depicted and described in connection with FIG. 23), or a transmission component (for example, transmission component 2304 depicted and described in connection with FIG. 23), among other examples.

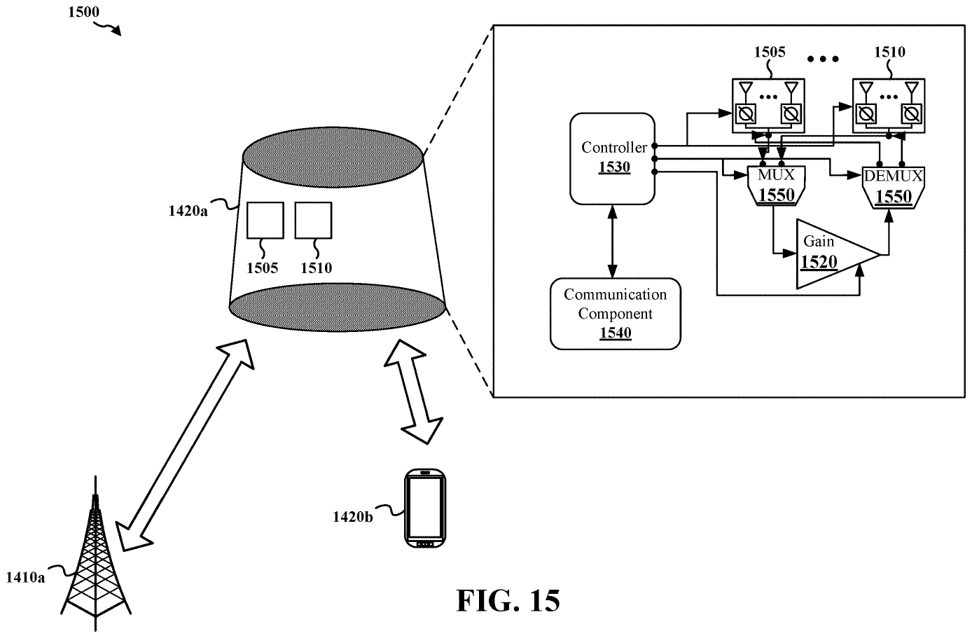

FIG. 15 is a diagram illustrating an example 1500 of a mmW device in accordance with the present disclosure. The example 1500 includes a wireless communication device or a UE 1420a that may be an example of a CPE, a network node 1410, and a UE 1420b, both in wireless communication with the UE 1420a via a wireless communication link. The UE 1420a may include telecommunications and/or information technology equipment that operates at a customer's or user's physical location and may include a mmW device for communications in mmW frequency bands. The UE 1420a may include a set of one or more antenna arrays or antenna panels including an antenna array. For example, the UE 1420a in the example 1500 include a first antenna panel 1505 and a second antenna panel 1510. The UE 1420a may include one or more antenna panels in addition to antenna panels 1505 and 1510, a gain component 1520, a controller 1530, a communication component 1540, and a multiplexer (MUX) and/or demultiplexer (DEMUX) (MUX/DEMUX) 1550.

The antenna panels 1505 and/or 1510 may include multiple antenna elements capable of being configured for beamforming. In some aspects, the antenna panel 1505 and/or the antenna panel 1510 may be a fixed receive antenna array capable of only receiving communications while not transmitting communications. In some aspects, the antenna panel 1505 and/or the antenna panel 1510 may be a fixed transmit antenna array capable of only transmitting communications while not receiving communications. In some aspects, the antenna panel 1505 and/or the antenna panel 1510 may be capable of being configured to act as a receive antenna array and/or a transmit antenna array, and/or may be configured for full duplex communications. The antenna panel 1505 and/or the antenna panel 1510 may be capable of communicating using mmW frequency bands.

Gain component 1520 includes a component capable of amplifying an input signal and outputting an amplified signal. For example, gain component 1520 may include a power amplifier and/or a variable gain component. In some aspects, gain component 1520 may have variable gain control. The gain component 1520 may connect to an receive antenna array and a transmit antenna array such that a millimeter wave signal, received via the receive antenna array, can be amplified by the gain component 1520 and output to the transmit antenna array for transmission. In some aspects, the level of amplification of the gain component 1520 may be controlled by the controller 1530.

Controller 1530 includes a component capable of controlling one or more other components of the UE 1420a. For example, the controller 1530 may include a controller, a microcontroller, and/or a processor. In some aspects, the controller 1530 may control the gain component 1520 by controlling a level of amplification or gain applied by the gain component 1520 to an input signal. Additionally, or alternatively, the controller 1530 may control the antenna panel 1505 and/or the antenna panel 1510 by controlling a beamforming configuration for the antenna panel 1505 and/or the antenna panel 1510 (for example, one or more phase values, one or more phase offsets, one or more power parameters, one or more beamforming parameters, a transmit beamforming configuration, and/or an receive beamforming configuration), by controlling whether the antenna panel 1505 and/or the antenna panel 1510 acts as an receive antenna array and/or a transmit antenna array (for example, by configuring interaction and/or connections between the antenna panel 1505 and/or the antenna panel 1510 and a MUX/DEMUX 1550). Additionally, or alternatively, the controller 1530 may power on or power off one or more components of UE 1420a. In some aspects, the controller 1530 may control a timing of one or more of the above configurations.

Communication component 1540 may include a component capable of wirelessly communicating with a network node 1410 using a wireless technology other than millimeter wave (for example, via a control interface). For example, the communication component 1540 may communicate with the network node 1410 using a personal area network (PAN) technology (for example, Bluetooth or Bluetooth Low Energy (BLE)), a 4G or long term evolution radio access technology, a narrowband Internet of Things (NB-IoT) technology, a sub-6 GHz technology, a visible light communication technology, and/or the like. In some aspects, the communication component 1540 may use a lower frequency communication technology, and the antenna panel 1505 and/or the antenna panel 1510 may use a higher frequency communication technology (for example, millimeter wave). In some aspects, the antenna panel 1505 and/or the antenna panel 1510 may be used to transfer data between the UE 1420a and the network node 1410, and the communication component 1540 may be used to transfer control information between the UE 1420a and the network node 1410 (for example, a report, a configuration, and/or instructions to power on or power off one or more components).

MUX/DEMUX 1550 may be used to multiplex and/or demultiplex communications received from and/or transmitted to an antenna array (antenna panel 1510). For example, MUX/DEMUX 1550 may be used to switch an receive antenna array to a transmit antenna array.

In some aspects, one or more of the antenna panel 1505 and/or the antenna panel 1510, gain component 1520, controller 1530, communication component 1540, and/or MUX/DEMUX 1550 may perform one or more techniques associated with UE calibration of mmW devices for mechanical alignments, as described in more detail elsewhere herein.

Because millimeter wave communications have a higher frequency and shorter wavelength than other types of radio waves used for communications (for example, sub-6 GHz communications), millimeter wave communications may have shorter propagation distances and may be more easily blocked by obstructions than other types of radio waves. For example, a wireless communication that uses sub-7 GHz radio waves may be capable of penetrating a wall of a building or a structure to provide coverage to an area on an opposite side of the wall from a network node 1410 that communicates using the sub-7 GHz radio waves. However, a millimeter wave may not be capable of penetrating the same wall (for example, depending on a thickness of the wall and/or a material from which the wall is constructed). Some techniques and apparatuses described herein use a mmW device, such as UE 1420a to increase the coverage area of a network node 1410 and/or to extend coverage to other UEs.

The UE 1420a may perform directional communication by using antenna panels 1505 and/or 1510 and beamforming to communicate with a network node 1410 via. For example, in example 1500, UE 1420a can communicate with the network node 1410 via a first beam pair and can communicate with UE 1420b via a second beam pair. A beam pair may refer to a transmit beam used by a first device for transmission and a receive beam used by a second device for reception of information transmitted by the first device via the Tx beam.

A network node may use a beam sweeping procedure to transmit communications via multiple beams over time (for example, using time division multiplexing (TDM)). The UE 1420a may receive a communication via an Rx beam of the UE 1420a. The UE 1420a may relay each received communication via multiple Tx beams of the UE 1420a. As used herein, relaying a communication may refer to transmitting the received communication (for example, after amplifying the received communication) without decoding the received communication and/or without modifying information carried in the received communication. Alternatively, relaying a received communication may refer to transmitting the received communication after decoding the received communication and/or modifying information carried in the received communication. In some aspects, a received communication may be relayed using a different time resource, a different frequency resource, and/or a different spatial resource (for example, a different beam) to transmit the communication as compared to a time resource, a frequency resource, and/or a spatial resource in which the communication was received. The UE 1420b may receive a relayed communication. In some aspects, the UE 1420b may generate a communication to be transmitted to the network node 1410. The UE 1420b may then transmit the communication to the UE 1420a for relaying to the network node 1410.

The antenna panel 1505 and/or the antenna panel 1510 may be co-located and/or similarly located for communications with a single network node. The 1420a may include a mechanical displacement apparatus (for example, at least one motor) that may rotate, reflect, or displace the antenna panel 1505 and/or the antenna panel 1510 and/or any corresponding components, such as the reflector. The mechanical displacement apparatus may separate and/or displace the antenna panel 1505 and/or the antenna panel 1510. In such examples, the displacement may be linear, angular, and or rotational.

Some CPEs, such as the UE 1420a, may include large antenna arrays (for example, 8×8 dual-polarized antenna arrays, 16×8 dual-polarized antenna arrays, and/or 16×16 dual-polarized antenna arrays) which may cost more than smaller arrays. As demand for lower-cost implementations for CPEs increases, CPEs may implemented with smaller antenna arrays. Some CPEs, such as the UE 1420a, may include a reflector and/or a mechanical rotator corresponding to each antenna panel, which may support communication parameters such as radiated power and array gain without the use of large antenna arrays. Smaller antenna arrays supported by a reflector and/or a mechanical rotator may also support power consumption, thermal overhead, and overall cost of the materials to manufacture the UE 1420a.

Moveable antenna panels 1505 and 1510 may be associated with or introduce challenges in wireless communication systems due to the reliance on mechanical movements for beamforming, which are inherently slower compared to the rapid symbol periods characteristic of electrical movements. As these panels transition from one position to another, achieving joint or coordinated communications across multiple panels necessitates a comprehensive beam search to mitigate inter-beam interference. Typically, beam management involves searching over different beams from each panel 1505 and 1510 to enhance performance. However, this approach may be accompanied by significant beam training overhead, which can strain network resources and reduce efficiency.

Other examples of the UE 1420a may differ from what is described in FIG. 15. For example, the UE 1420a may include additional components, fewer components, different components, or differently arranged components than those shown in FIG. 15. Furthermore, two or more components shown in FIG. 15 may be implemented within a single component, or a single component shown in FIG. 15 may be implemented as multiple components. Additionally, or alternatively, a set of components (for example, one or more components) of the UE 1420a may perform one or more functions described as being performed by another set of components of UE 1420a.

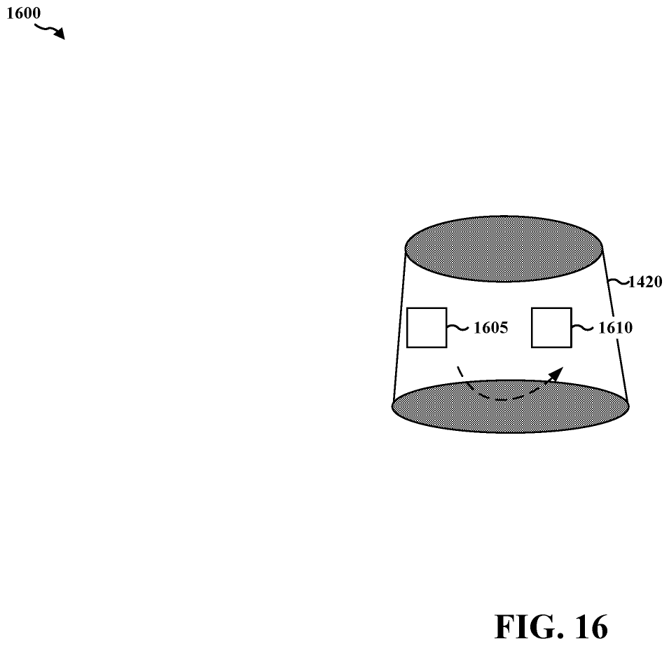

FIG. 16 is a diagram illustrating an example 1600 of a mmW device with adjustable antenna panels in accordance with the present disclosure. The example 1600 includes a UE 1420 that may be an example of a CPE. The UE 1420 may include telecommunications and/or information technology equipment that operates at a customer's or user's physical location and may include a mmW device for communications in mmW frequency bands. The UE 1420 may include a set of one or more antenna arrays or antenna panels including an antenna array. For example, the UE 1420 in the example 1600 includes at least a first antenna panel 1605 and a second antenna panel 1610. The UE 1420 may be an example of the UE 1420 as described with reference to FIG. 15.

The example 1600 may depict a scenario for communications in which the second antenna panel 1610 may be mechanically rotated and/or displaced relative to the first antenna panel 1605 and at least one mechanical displacement apparatus (for example, such as at least one motor) has rotated, reflected and/or displaced the antenna panel 1610 such that the antenna panel 1605 and the antenna panel 1610 are non-co-located. For example, the at least one mechanical displacement may mechanically separate and/or displace the panels in the UE 1420 to perform directional communications with a network node. Such angular separation between the antenna panel 1605 and the antenna panel 1610 may be introduced during a mechanical alignment phase (for example, the mechanical alignment phase operation may take the UE 1420 a relatively long time (for example, in the order of seconds and/or minutes) to complete and transition to communicating with the multiple network nodes).

In some aspects, the UE 1420 may be enabled to perform full duplex and/or sub-band full duplex operation. In such aspects, the first antenna panel 1605 (or, for example, a first subset of panels of the UE 1420) may communicate via a first carrier frequency, a first frequency range, and/or a first frequency band. The second antenna panel 1610 (or, for example, a second subset of panels of the UE 1420) may communicate via a second carrier frequency, a second frequency range, and/or a second frequency band. In such examples, the antenna panel 1605 and the antenna panel 1610 may be connected to a same network node and/or different network nodes.

When at least one of the antenna panel 1605 and the antenna panel 1610 are moved to a new position, the alignment of beams across multiple panels becomes influential for maintaining coherent communications. Coordinated transmission or reception across the antenna panels 1605 and 1610 can improve SNR, particularly in cell-edge scenarios. However, achieving coherent communication may depend on beam management and refinement, including the selection of appropriate beams and the determination of co-phasing factors to align signals from multiple panels. Incorrect beam alignment or co-phasing can result in increased inter-beam interference, degraded SNR, and reduced communication performance.

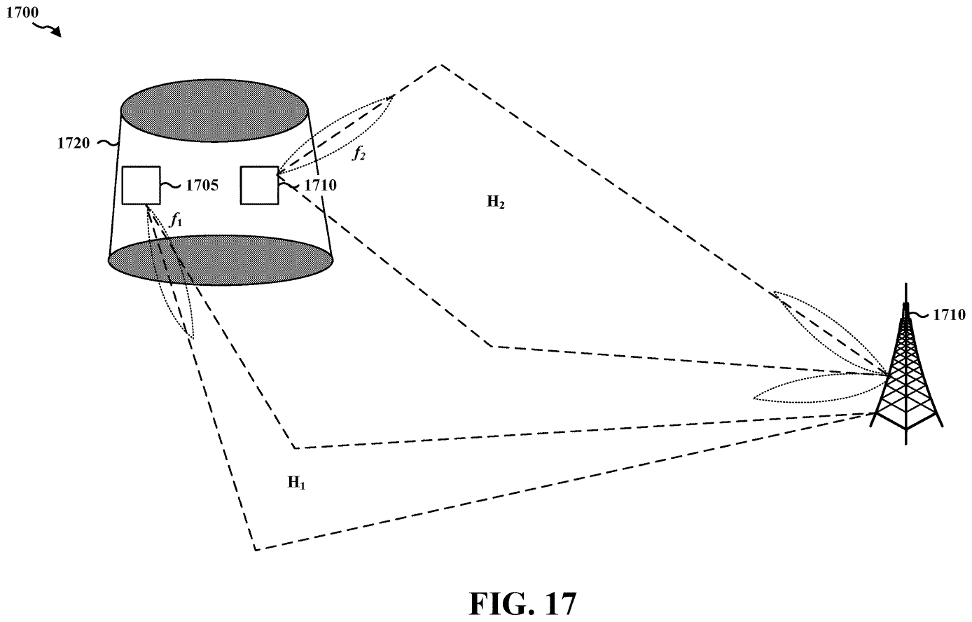

FIG. 17 is a diagram illustrating an example 1700 of directional communications between a CPE and a network node, in accordance with the present disclosure.

In the example 1700, a wireless communication device 1720 may include a first antenna panel 1705 and a second antenna panel 1710. The first antenna panel 1705 may communicate with a network node 1410 using a first frequency f₁ and the second antenna panel 1710 may communicate with the network node 1410 using a second frequency f₂. The first antenna panel and the second antenna panel 1710 may coordinate the respective communication beams over a single layer, for example, to improve SNR for cell edge coverage. The UE 1420 may perform a beam management procedure to determine one or more suitable beams for communications at the first antenna panel, the second antenna panel, or both.

At a given location, the wireless communication device 1720 may determine the best beam indices that work with either antenna panel 1705 or antenna panel 1710. For example, the wireless communication device 1720 may assign the beam corresponding to a first SSB index (e.g., SSB1) to the first antenna panel 1705 and may assign the beam corresponding to a second SSB index (e.g., SSB2) to the second antenna panel 1710.

However, the wireless communication device 1720 may not have information indicating whether these beam pairs (or any other beam pair) will lead to low inter-beam interference for coordinated communications across panels.

In some examples, the wireless communication device 1720 may provide TCI state feedback of SSB₁ and SSB₂ to the network node 1410 for determining whether these beam pairs (or any other beam pair) will lead to low inter-beam interference for coordinated communications across panels. The network node 1410 may transmit one or more CSI-RSs for the potential SSB combinations such that the wireless communication device 1720 may evaluate the inter-beam interference and select the best beam pairs. For example, the wireless communication device 1720 may determine f₁ and f₂ from the first antenna panel 1705 and the second antenna panel 1710, respectively, to calculate a signal transmitted by each antenna panel to the network node 1410 or to calculate the inter-beam or inter-panel interference.

The quantity of combinations of SSBs can be substantial, resulting in significant network overhead during beam training. Additionally, when the panels within the wireless communication device 1720 change position, retraining the beams can be resource-intensive, even though the beams across the panels may remain unchanged. For example, such beam management approaches may involve extensive beam training and feedback between the wireless communication device 1720 and the network node 1410. These methods typically require the CPE to provide feedback on potential beam combinations, which the network node uses to transmit reference signals for beam refinement and selection, thereby increasing overhead. Additionally, the feedback and refinement process may be resource-intensive when the quantity of potential beam combinations is large, further straining network resources.

The dynamic nature of mechanical displacement introduces variability in the local geometry of the antenna modules relative to each other, and the observed channel environment of the wireless communication device 1720, which in combination with the unpredictable variations in the environment or obstructions or blockages (e.g., local environment) between the wireless communication device and the network node 1410, can affect the efficacy of previously trained beams. For example, temporary obstructions or blockages or changes in the orientation of panels may degrade the performance of previously selected beams. Without an efficient mechanism to adapt to these changes, the CPE may experience degraded communication quality, reduced data rates, and increased latency.

Overall, the use of mechanically steerable antenna panels 1705 and 1710 in low-cost CPE implementations raises challenges related to slow panel movements, coordinated beam management, network overhead, and dynamic environmental changes.

As indicated above, FIG. 17 is provided as an example. Other examples may differ from what is described with respect to FIG. 17.

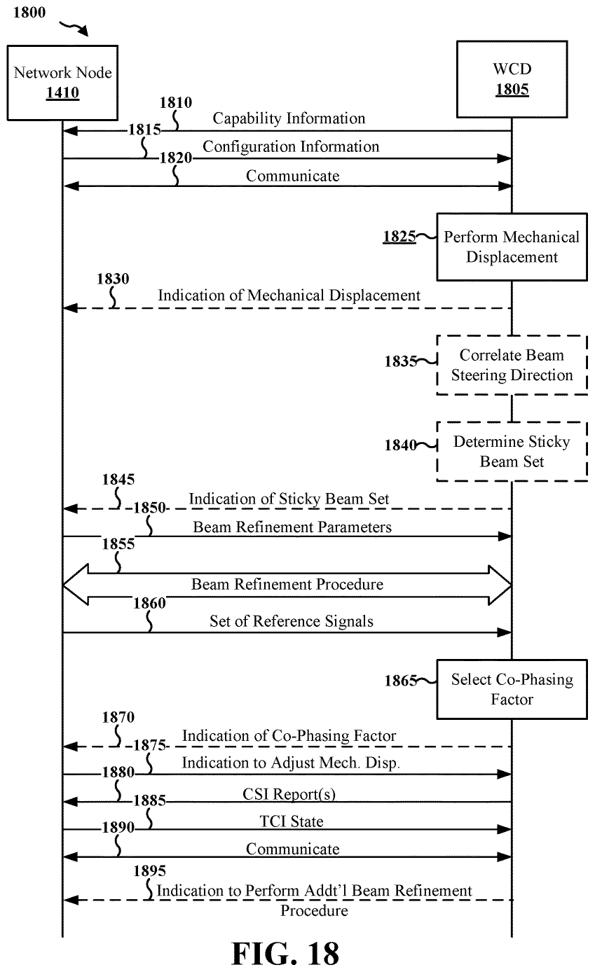

FIG. 18 is a diagram of an example 1800 associated with semi-deterministic beam management in devices with moveable antenna panels. “Semi-deterministic beam management” refers to a beam management process where one or more beam parameters (e.g., such as pointing direction) are predictable or derivable from a local coordinate system of a wireless communication device, and one or more parameters (e.g., such as co-phasing factors) are not and therefore are identified by performing one or more other procedures. As shown in FIG. 18, a network node 1410 (e.g., a base station, a CU, a DU, or an RU) may communicate with a wireless communication device (WCD) 1805, which may be an example of a UE 1420 or a CPE. In some aspects, the network node 1410 and the WCD 1805 may be part of a wireless network (e.g., the wireless communication network 1400). The WCD 1805 and the network node 1410 may have established a wireless connection prior to operations shown in FIG. 18. FIG. 18 depicts an example sequence of operations associated with semi-deterministic beam management using moveable antenna panels, where the WCD 1805 performs beam selection and determines steering directions based on panel positions, a local coordinate system, and environmental conditions, which may facilitate efficient communication setups and reduce overhead in dynamic wireless environments.

In some aspects, as shown by reference number 1810, the WCD 1805 may transmit capability information. The capability information may be included in a capability report. The WCD 1805 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the WCD 1805. The one or more parameters may be indicated via respective information elements (IEs) included in a capability report.

The capability information may indicate whether the WCD 1805 supports a feature or one or more parameters related to the feature. For example, the capability information may indicate a capability or parameter for semi-deterministic beam management by leveraging moveable antenna panels to enhance beam selection. As another example, the capability information may indicate a capability or parameter for transmitting configuration information that includes details about the current panel positions and preferred beam steering directions based on local environment conditions of the WCD 1805. One or more operations described herein may be based on capability information. For example, the WCD 1805 may perform a communication in accordance with the capability information, or may receive configuration information that is in accordance with the capability information. In some aspects, the capability information may indicate WCD 1805 support for mechanical displacement of antenna panels to improve signal reception, use of a Cassegrain reflector for enhanced effective isotropic radiated power (EIRP) and array gain, correlating beam steering directions according to mechanical displacement, and selection of sticky beam sets and co-phasing factors for enhanced communication coordination.

As shown by reference number 1815, the network node 1410 may transmit, and the WCD 1805 may receive, configuration information. In some aspects, the WCD 1805 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the WCD 1805 or previously indicated by the network node 1410 or other network device), or explicit configuration information for the WCD 1805 to use to configure the WCD 1805, among other examples.

In some examples, the configuration information may not be expressly signaled to the WCD 1805. For example, in some aspects, the configuration information may at least partially be defined by a wireless communication standard, such as the 3GPP. In such examples, the network node 1410 may not explicitly indicate such configuration information to the WCD 1805. For example, the WCD 1805 may optionally obtain at least a portion of the configuration information from a configuration stored by the WCD 1805 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the WCD 1805 is to transmit capability information indicating its ability to support semi-deterministic beam management by leveraging moveable antenna panels to enhance beam selection. Additionally, the WCD 1805 may transmit configuration information that includes details about the current panel positions and preferred beam steering directions based on local environment conditions. Furthermore, the WCD 1805 may communicate with a network node 1410 using a plurality of antenna panels, including a first antenna panel at a first location, one or more messages via a first communication beam corresponding to a first beam steering direction. The WCD 1805 may also perform a mechanical displacement of the first antenna panel from the first location to a second location to improve signal reception based on changed environmental conditions. The WCD 1805 may transmit an indication of the mechanical displacement of the first antenna panel to the network node 1410, potentially utilizing UCI or MAC-CE for signaling. Moreover, the WCD 1805 may correlate the beam steering direction of the second communication beam to the first beam steering direction according to a local coordinate system of the wireless communication device and determine a sticky beam set for the first antenna panel at the second location, which is stored in a codebook of the first antenna panel. The WCD 1805 may transmit an indication of the sticky beam set associated with the first antenna panel to the network node 1410, facilitating quicker network adaptation to changing panel positions.

The WCD 1805 may configure itself based at least in part on the configuration information. In some aspects, the WCD 1805 may be configured to perform one or more operations described herein based at least in part on the configuration information.

In some aspects, as shown by reference number 1820, the WCD 1805 may communicate with a network node 1410, using a plurality of antenna panels including a first antenna panel at a first location, one or more messages via a first communication beam corresponding to a first beam steering direction.

For example, the WCD 1805 may use a predefined beam steering direction that has been determined to be optimal for the current panel configuration and location. As a result, communicating with the network node 1410 using a plurality of antenna panels may enhance signal quality and reduce interference.

In some aspects, as shown by reference number 1825, the WCD 1805 may perform a mechanical displacement of the first antenna panel from the first location to a second location. For example, the WCD 1805 may rotate a panel to a new position using a mechanical rotator to improve signal reception based on changed environmental conditions. As a result, performing a mechanical displacement may allow for flexible adaptation to varying signal environments without requiring large antenna arrays. In some aspects, mechanical displacement may be performed using a motor. For example, the WCD 1805 may employ a Cassegrain reflector to enhance effective isotropic radiated power (EIRP) and array gain, providing improved signal coverage and quality. Using a Cassegrain reflector may allow for better EIRP and increased array gain without the need for large antenna arrays.

In some aspects, as shown by reference number 1830, the WCD 1805 may transmit an indication of the mechanical displacement of the first antenna panel to the network node 1410. For example, the WCD 1805 can send a message to the network node 1410 indicating the new position of the panel and its impact on current beam configurations. As a result, transmitting an indication of mechanical displacement may help the network node 1410 adjust its communication parameters accordingly. In some aspects, transmitting an indication may be done via UCI or MAC-CE. For example, the WCD 1805 may utilize UCI or a MAC-CE to convey detailed panel positioning updates to the network node 1410. Utilizing UCI or MAC-CE for signaling may provide accurate and reliable communication of displacement information.

In some aspects, as shown by reference number 1835, the WCD 1805 may correlate the beam steering direction of the second communication beam to the first beam steering direction according to a local coordinate system of the WCD 1805. For example, the WCD 1805 may use a pre-defined local coordinate system (e.g., a coordinate system with the WCD 1805 at the center of the coordinate system, or a coordinate system that is relative to the WCD 1805 as a reference point) to align the new beam steering direction closely with previously enhanced directions. As a result, correlating beam steering directions may minimize inter-beam interference and improve overall communication efficiency.

In some aspects, as shown by reference number 1840, the WCD 1805 may determine a sticky beam set for the first antenna panel at the second location that corresponds to the second location of the first antenna panel and is stored in a codebook of the first antenna panel. For example, the WCD 1805 may select a set of beams that have historically provided reliable performance at similar positions and store them for future reference. As a result, determining a sticky beam set may reduce the need for extensive beam training and enhance communication reliability. In some aspects, mechanical displacement may trigger SSB set re-selection. For example, after a panel is mechanically moved, the WCD 1805 may re-select certain SSB sets to align with the sticky beam set for coordinated communication. Re-selecting SSB sets based on sticky beams may streamline the transition and maintain consistent communication performance.

In some aspects, as shown by reference number 1845, the WCD 1805 may transmit, to the network node 1410, an indication of the sticky beam set associated with the first antenna panel, wherein the sticky beam set includes the second communication beam. For example, the WCD 1805 may notify the network node 1410 that the selected sticky beam set is valid for the current panel positioning, allowing for streamlined communication processes. As a result, transmitting an indication of the sticky beam set may facilitate quicker network adaptation to changing panel positions.

In some aspects, as shown by reference number 1850, the WCD 1805 may receive, from the network node 1410, an indication of one or more beam refinement parameters associated with the first antenna panel at the second location. For example, the network node 1410 may send updated parameters that help the WCD 1805 adjust its beam steering for enhanced performance at the new panel location. As a result, receiving beam refinement parameters may provide continued communication quality despite panel movements. In some aspects, indicating the validity of CSI-RS beam refinement may be done via a CRI report. For example, the WCD 1805 may inform the network node 1410 that the previously selected CSI-RS beam refinement remains effective through a CRI report. Indicating CSI-RS beam refinement validity may support efficient communication adjustments and resource allocation.

In some aspects, as shown by reference number 1855, the WCD 1805 may perform a beam refinement procedure for the plurality of antenna panels including the first antenna panel at the second location to select a second communication beam in coordination with a third communication beam associated with a second antenna panel. For example, the WCD 1805 may use a semi-deterministic protocol to efficiently coordinate beam selection between multiple panels to mitigate interference. As a result, performing a beam refinement procedure may enhance signal coherence and reduce communication delays. In some aspects, correlating a beam steering direction may include correlating a beam steering direction of the second communication beam with the beam steering direction of the first communication beam according to the mechanical displacement of the first antenna panel.

For example, the WCD 1805 may adjust its beam steering direction based on the known mechanical displacement pattern to align with previous configurations. Correlating beam steering directions according to mechanical displacement may facilitate smoother transitions in beam management. In some aspects, mechanical displacement may be multi-dimensional. For example, the WCD 1805 (UE 1420) may track and adjust panel movements across X, Y, and Z dimensions when transitioning from one location to another.

In some aspects, receiving a set of reference signals may include receiving a set of reference signals corresponding to a set of co-phasing factors between the second communication beam and the third communication beam; and selecting a co-phasing factor from the set of co-phasing factors for coordinated communications via the second communication beam associated with the first antenna panel and the third communication beam associated with the second antenna panel. For example, the WCD 1805 may analyze the received reference signals to select a co-phasing factor that enhances coordination between the panels. Selecting a co-phasing factor based on reference signals may improve signal coherence across multiple beams. A co-phasing factor (or, for example, phase alignment factor) is a factor that is applied to a waveform in wireless communications—for example, in MIMO, beamforming, or coherent combining—to align the phases of signals such that the waveforms combine constructively at a reception point (e.g., the network node 1410).

In some aspects, as shown by reference number 1860, the WCD 1805 may receive a set of reference signals. For example, the WCD 1805 may obtain reference signals to help calibrate its communication beams and provide accurate steering directions. As a result, receiving a set of reference signals may provide a basis for effective beam alignment and configuration.

In some aspects, as shown by reference number 1865, the WCD 1805 may select a co-phasing factor. For example, the WCD 1805 may determine an optimal co-phasing factor based on the relative positioning and orientation of antenna panels to maximize signal gain. As a result, selecting a co-phasing factor may enhance signal coherence across multiple communication beams.

In some aspects, as shown by reference number 1870, the WCD 1805 may transmit, to the network node 1410, an indication of the co-phasing factor. For example, the WCD 1805 may communicate the selected co-phasing factor to the network node 1410 to enable synchronized beam adjustments. As a result, transmitting an indication of the co-phasing factor may provide seamless coordination between network and WCD 1805 beam configurations.

In some aspects, as shown by reference number 1875, the WCD 1805 may receive, from the network node 1410, an indication to adjust the mechanical displacement of the first antenna panel for identifying one or more TCI states associated with communications via the second antenna panel. For example, the network node 1410 may suggest specific panel adjustments to enhance TCI state identification. As a result, receiving an indication to adjust mechanical displacement may help maintain efficient communication setups as panel positions change.

In some aspects, as shown by reference number 1880, the WCD 1805 may transmit, to the network node 1410, one or more CSI reports associated with the first communication beam and the second communication beam. For example, the WCD 1805 may provide detailed channel quality metrics for each beam to assist the network node 1410 in refining communication parameters. As a result, transmitting CSI reports may help maintain high-quality communication links.

In some aspects, as shown by reference number 1885, the WCD 1805 may receive, from the network node 1410, an indication of a TCI state associated with the second communication beam. For example, the network node 1410 may update the WCD 1805 on the current TCI state to guide future beam selections and adjustments. As a result, receiving an indication of a TCI state may support dynamic, responsive communication strategies.

In some aspects, as shown by reference number 1890, the WCD 1805 may communicate with the network node 1410, using the first antenna panel at the second location, one or more messages via the second communication beam corresponding to a second beam steering direction that is correlated to the first beam steering direction according to a local coordinate system of the WCD 1805. For example, the WCD 1805 may maintain communication consistency by aligning the new beam steering direction with previously successful configurations. As a result, communicating with the network node 1410 using a correlated beam steering direction may enhance reliability and reduce setup time.

In some aspects, communicating the one or more messages may include communicating the one or more messages via the second communication beam using the first antenna panel and the third communication beam using the second antenna panel according to the co-phasing factor. For example, the WCD 1805 may simultaneously transmit messages using the selected co-phasing factor to provide coherent beam coordination. Communicating via multiple beams using co-phasing factors may enhance signal robustness and integrity.

In some aspects, as shown by reference number 1895, the WCD 1805 may transmit, to the network node 1410, an indication to perform the beam refinement procedure again for the first antenna panel in accordance with at least one of an expiry of a timer, a detected change in local geometry of the WCD 1805, a detected change in local geometry of an environment of the WCD 1805, or a detected change in channel quality. For example, the WCD 1805 may signal the network node 1410 to initiate beam refinement following significant changes in environmental factors or performance metrics. As a result, transmitting an indication to perform beam refinement again may provide adaptability to evolving communication contexts. In some aspects, one or more channel quality metrics associated with the second communication beam may satisfy a degradation threshold. For example, the WCD 1805 may assess the current signal quality and determine that the signal quality has fallen below a predefined standard, prompting an update to beam configurations. Satisfying a degradation threshold for channel quality metrics may trigger timely adjustments to maintain optimal communication performance.

As indicated above, FIG. 18 is provided as an example. Other examples may differ from what is described with regard to FIG. 18.

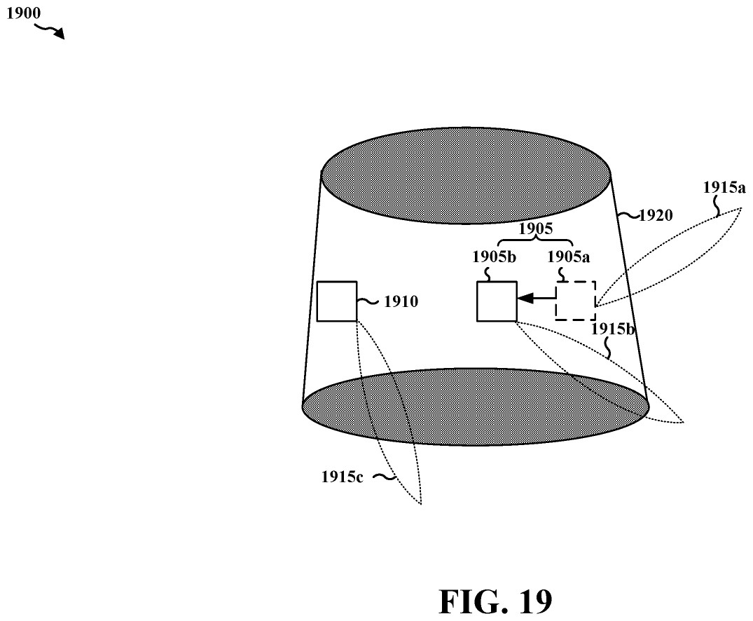

FIG. 19 is a diagram illustrating an example 1900 associated with sticky beam determination, in accordance with the present disclosure.

The example 1900 includes a wireless communication device 1920 including a first antenna panel at a first location 1905a, the first panel at the second location 1905b, and a second antenna panel 1910.

The wireless communication device 1920 may perform a mechanical adjustment of the antenna panel 1905 and may have information that indicates the precise mechanical movement of the antenna panel 1910 in X, Y, or Z dimensions as the first antenna panel is moved from the first location to the second location.

In the example 1900, the wireless device 1920 may have previously established (e.g., according to one or more previously performed beam management procedures) first communication beam 1915a and third communication beam 1915b as being effective for coordinated communications via the first communication panel at the first location 1905a and the second communication panel 1910, respectively.

Based on the mechanical displacement of the first antenna panel 1905 from the first location to the second location, the wireless communication device 1920 may derive an appropriate communication beam (e.g., second communication beam 1915b) from a codebook that is associated with the first antenna panel at the second location 1905a. The wireless communication device 1920 may select the second communication beam 1915b by correlating a steering direction of the second communication beam 1915b to a steering direction of the first communication beam 1915a according to a local coordinate system of the second antenna panel 1905. In some aspects, correlating the beam steering directions may depend on the precise movement of the first antenna panel at the first location 1905a to the second location 1905b. Relative to the local coordinate system, the steering direction of the second communication beam 1915b at the second location may be a relatively accurate estimation of the steering direction of the first communication beam 1915a at the first location.

However, the wireless communication device 1920 may not blindly use the second communication beam 1915b at the second location with the third communication beam 1915c for coordinated communications. This is because, depending on orientation/location and array sizes of the antenna panels 1905 and 1910, an effective co-phasing factor across beams 1915b and 1915c may lead to enhanced gains, and an ineffective choice of co-phasing factor across beams 1915b and 1915c can lead to degraded performance.

To avoid using ineffective co-phasing factors, the wireless communication device 1920 may provide an indication of “sticky” beams that the wireless communication device 1920 will use across panels, even as panels can change positions. Such indications may be provided via UCI or MAC-CE.

“Sticky beams” refers to specific communication beams that a device consistently uses across different panels, even when the panels change positions. These beams are characterized by their stability and reliability, serving as anchors for maintaining effective communication between the wireless communication device 1920 and a network node 1410. Sticky beams are utilized to reduce network overhead by allowing the reuse of established beams during beam refinement processes, ensuring efficient and continuous connectivity without the need for frequent retraining or adjustments.

When the network node 1410 selects SSB sets for the wireless communication device 1920 and/or an associated CSI-RS beam refinement (e.g., with a CRI report), the wireless communication device 1920 may indicate that the selection of the CRI for the CSI-RSs within each SSB refinement is still valid. The network node 1410 may then reuse the sticky beams for subsequent communications. This reduces network overhead, as the sticky beams provide the anchor to use for search in beam refinement. When one of the panels is mechanically displaced and the wireless communication device 1920 re-selects certain SSB sets again, the wireless communication device 1920 and network node 1410 may directly use the right beams based on the sticky beams. Over a period of time, the efficacy of sticky beams may degrade. This may be due to changes in the channel environment or local geometry. In such aspects, the wireless communication device 1920 may retrigger beam refinement based on an expiry of a timer or based on a detected degradation in signal quality caused by potential changes in a local environment. The retrigger signaling may be transmitted via UCI or MAC-CE, and retriggering the beam refinement process may be performed according to one or more configurations or one or more technical guidelines.

As indicated above, FIG. 19 is provided as an example. Other examples may differ from what is described with respect to FIG. 19.

FIG. 20 is a diagram illustrating an example process 2000 performed, for example, at a wireless communication device or an apparatus of a wireless communication device. Example process 2000 is an example where the apparatus or the wireless communication device (e.g., UE 1420) performs operations associated with semi-deterministic beam management in devices with moveable antenna panels.

As shown in FIG. 20, in some aspects, process 2000 may include communicating, with a network node using a plurality of antenna panels including a first antenna panel at a first location, one or more messages via a first communication beam corresponding to a first beam steering direction (block 2010). For example, the wireless communication device (e.g., using reception component 2202, transmission component 2204, or communication manager 2206, depicted in FIG. 22) may communicate, with a network node using a plurality of antenna panels including a first antenna panel at a first location, one or more messages via a first communication beam corresponding to a first beam steering direction, as described above.

As further shown in FIG. 20, in some aspects, process 2000 may include performing a mechanical displacement of the first antenna panel from the first location to a second location (block 2020). For example, the wireless communication device (e.g., using communication manager 2206, depicted in FIG. 22) may perform a mechanical displacement of the first antenna panel from the first location to a second location, as described above.

As further shown in FIG. 20, in some aspects, process 2000 may include performing a beam refinement procedure for the plurality of antenna panels including the first antenna panel at the second location to select a second communication beam in coordination with a third communication beam associated with a second antenna panel (block 2030). For example, the wireless communication device (e.g., using communication manager 2206, depicted in FIG. 22) may perform a beam refinement procedure for the plurality of antenna panels including the first antenna panel at the second location to select a second communication beam in coordination with a third communication beam associated with a second antenna panel, as described above.

As further shown in FIG. 20, in some aspects, process 2000 may include communicating, with the network node using the first antenna panel at the second location, one or more messages via the second communication beam corresponding to a second beam steering direction that is correlated to the first beam steering direction according to a local coordinate system of the wireless communication device (block 2040). For example, the wireless communication device (e.g., using reception component 2202, transmission component 2204, or communication manager 2206, depicted in FIG. 22) may communicate, with the network node using the first antenna panel at the second location, one or more messages via the second communication beam corresponding to a second beam steering direction that is correlated to the first beam steering direction according to a local coordinate system of the wireless communication device, as described above.

Process 2000 may include additional aspects, such as any single aspect or any combination of aspects described below or in connection with one or more other processes described elsewhere herein.

In a first aspect, process 2000 includes transmitting an indication of the mechanical displacement of the first antenna panel to the network node.

In a second aspect, alone or in combination with the first aspect, the beam refinement procedure comprises correlating a beam steering direction of the second communication beam with the beam steering direction of the first communication beam according to the mechanical displacement of the first antenna panel.

In a third aspect, alone or in combination with one or more of the first and second aspects, process 2000 includes determining a sticky beam set for the first antenna panel at the second location that corresponds to the second location of the first antenna panel and is stored in a codebook of the first antenna panel.

In a fourth aspect, alone or in combination with one or more of the first through third aspects, process 2000 includes transmitting, to the network node, an indication of the sticky beam set associated with the first antenna panel, wherein the sticky beam set includes the second communication beam.

In a fifth aspect, alone or in combination with one or more of the first through fourth aspects, the beam refinement procedure comprises receiving a set of reference signals corresponding to a set of co-phasing factors between the second communication beam and the third communication beam, and selecting a co-phasing factor from the set of co-phasing factors for coordinated communications via the second communication beam associated with the first antenna panel and the third communication beam associated with the second antenna panel.

In a sixth aspect, alone or in combination with one or more of the first through fifth aspects, process 2000 includes communicating the one or more messages via the second communication beam using the first antenna panel and the third communication beam using the second antenna panel according to the co-phasing factor.

In a seventh aspect, alone or in combination with one or more of the first through sixth aspects, process 2000 includes transmitting, to the network node, an indication of the co-phasing factor.

In an eighth aspect, alone or in combination with one or more of the first through seventh aspects, process 2000 includes receiving, from the network node, an indication of one or more beam refinement parameters associated with the first antenna panel at the second location.

In a ninth aspect, alone or in combination with one or more of the first through eighth aspects, the second communication beam is selected using the local coordinate system of the wireless communication device and a codebook associated with the first antenna panel.

In a tenth aspect, alone or in combination with one or more of the first through ninth aspects, process 2000 includes transmitting, to the network node, an indication to perform the beam refinement procedure again for the first antenna panel in accordance with at least one of an expiry of a timer, a detected change in local geometry of the wireless communication device, a detected change in local geometry of an environment of the wireless communication device, or a detected change in channel quality.

In an eleventh aspect, alone or in combination with one or more of the first through tenth aspects, one or more channel quality metrics associated with the second communication beam satisfy a degradation threshold.

In a twelfth aspect, alone or in combination with one or more of the first through eleventh aspects, process 2000 includes receiving, from the network node, an indication to adjust the mechanical displacement of the first antenna panel for identifying one or more TCI states associated with communications via the second antenna panel.

In a thirteenth aspect, alone or in combination with one or more of the first through twelfth aspects, process 2000 includes transmitting, to the network node, one or more channel state reports associated with the first communication beam and the second communication beam.

In a fourteenth aspect, alone or in combination with one or more of the first through thirteenth aspects, process 2000 includes receiving, from the network node, an indication of a TCI state associated with the second communication beam.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram illustrating an example process 2100 performed, for example, at a network node or an apparatus of a network node. Example process 2100 is an example where the apparatus or the network node (e.g., network node 1410) performs operations associated with semi-deterministic beam management in devices with moveable antenna panels.

As shown in FIG. 21, in some aspects, process 2100 may include communicating, with a wireless communication device that is using a plurality of antenna panels including a first antenna panel at a first location, one or more messages via a first communication beam that corresponds to a first beam steering direction (block 2110). For example, the network node (e.g., using reception component 2302, transmission component 2304, or communication manager 2306, depicted in FIG. 23) may communicate, with a wireless communication device that is using a plurality of antenna panels including a first antenna panel at a first location, one or more messages via a first communication beam that corresponds to a first beam steering direction, as described above.

As further shown in FIG. 21, in some aspects, process 2100 may include performing, via one or more communications with the wireless communication device, a beam refinement procedure for communicating with the plurality of antenna panels including the first antenna panel at a second location to select a second communication beam in coordination with a third communication beam that is associated with a second antenna panel (block 2120). For example, the network node (e.g., using communication manager 2306, depicted in FIG. 23) may perform, via one or more communications with the wireless communication device, a beam refinement procedure for communicating with the plurality of antenna panels including the first antenna panel at a second location to select a second communication beam in coordination with a third communication beam that is associated with a second antenna panel, as described above.

As further shown in FIG. 21, in some aspects, process 2100 may include communicating, with the wireless communication device that is using the first antenna panel at the second location, one or more messages via the second communication beam corresponding to a second beam steering direction that is correlated to the first beam steering direction according to a local coordinate system of the wireless communication device (block 2130). For example, the network node (e.g., using reception component 2302, transmission component 2304, or communication manager 2306, depicted in FIG. 23) may communicate, with the wireless communication device that is using the first antenna panel at the second location, one or more messages via the second communication beam corresponding to a second beam steering direction that is correlated to the first beam steering direction according to a local coordinate system of the wireless communication device, as described above.

Process 2100 may include additional aspects, such as any single aspect or any combination of aspects described below or in connection with one or more other processes described elsewhere herein.

In a first aspect, process 2100 includes receiving an indication of a mechanical displacement of the first antenna panel to the network node.

In a second aspect, alone or in combination with the first aspect, process 2100 includes receiving, from the wireless communication device, an indication of a sticky beam set for the first antenna panel at the second location, wherein the sticky beam set includes the second communication beam.

In a third aspect, alone or in combination with one or more of the first and second aspects, the beam refinement procedure comprises transmitting a set of reference signals corresponding to a set of co-phasing factors between the second communication beam and the third communication beam for selection of a co-phasing factor from the set of co-phasing factors.

In a fourth aspect, alone or in combination with one or more of the first through third aspects, process 2100 includes communicating the one or more messages via the second communication beam from the first antenna panel and the third communication beam from the second antenna panel according to the co-phasing factor.

In a fifth aspect, alone or in combination with one or more of the first through fourth aspects, process 2100 includes receiving, from the wireless communication device, an indication of the co-phasing factor for coordinated communications via the second communication beam associated with the first antenna panel and the third communication beam associated with the second antenna panel.

In a sixth aspect, alone or in combination with one or more of the first through fifth aspects, process 2100 includes transmitting, to the wireless communication device, an indication of one or more beam refinement parameters associated with the first antenna panel at the second location.

In a seventh aspect, alone or in combination with one or more of the first through sixth aspects, the second communication beam is selected using the local coordinate system of the wireless communication device and a codebook associated with the first antenna panel.

In an eighth aspect, alone or in combination with one or more of the first through seventh aspects, process 2100 includes receiving, from the wireless communication device, an indication to perform the beam refinement procedure again for the plurality of antenna panels in accordance with at least one of an expiry of a timer, a detected change in local geometry of the wireless communication device, a detected change in local geometry of an environment of the wireless communication device, or a detected change in channel quality.

In a ninth aspect, alone or in combination with one or more of the first through eighth aspects, one or more channel quality metrics associated with the second communication beam satisfy a degradation threshold.

In a tenth aspect, alone or in combination with one or more of the first through ninth aspects, process 2100 includes transmitting, to the wireless communication device, an indication to adjust a mechanical displacement of the first antenna panel for identifying one or more TCI states associated with communications via the second antenna panel.

In an eleventh aspect, alone or in combination with one or more of the first through tenth aspects, process 2100 includes receiving, from the wireless communication device, one or more channel state reports associated with the first communication beam and the second communication beam.

In a twelfth aspect, alone or in combination with one or more of the first through eleventh aspects, process 2100 includes transmitting, to the wireless communication device, an indication of a TCI state associated with the second communication beam.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram of an example apparatus 2200 for wireless communication. The apparatus 2200 may be a wireless communication device, or a wireless communication device may include the apparatus 2200. In some aspects, the apparatus 2200 includes a reception component 2202, a transmission component 2204, or a communication manager 2206, which may be in communication with one another (for example, via one or more buses or one or more other components). In some aspects, the communication manager 2206 is the communication manager 1450 described in connection with FIG. 14. As shown, the apparatus 2200 may communicate with another apparatus 2208, such as a UE or a network node (such as a CU, a DU, an RU, or a base station), using the reception component 2202 and the transmission component 2204. The communication manager 2206 may be included in, or implemented via, a processing system (for example, the processing system 1440 described in connection with FIG. 14) of the wireless communication device.

In some aspects, the apparatus 2200 may be configured to perform one or more operations described herein in connection with FIGS. 18-19. Additionally, or alternatively, the apparatus 2200 may be configured to perform one or more processes described herein, such as process 2000 of FIG. 20, or a combination thereof. In some aspects, the apparatus 2200 or one or more components shown in FIG. 22 may include one or more components of the wireless communication device described in connection with FIG. 14. Additionally, or alternatively, one or more components shown in FIG. 22 may be implemented within one or more components described in connection with FIG. 14. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2202 may receive communications, such as reference signals, control information, data communications, or a combination thereof, from the apparatus 2208. The reception component 2202 may provide received communications to one or more other components of the apparatus 2200. In some aspects, the reception component 2202 may perform signal processing on the received communications, and may provide the processed signals to the one or more other components of the apparatus 2200. In some aspects, the reception component 2202 may include one or more components of the wireless communication device described above in connection with FIG. 14, such as a radio, one or more RF chains, one or more transceivers, or one or more modems, each of which may in turn be coupled with one or more antennas of the wireless communication device.

The transmission component 2204 may transmit communications, such as reference signals, control information, data communications, or a combination thereof, to the apparatus 2208. In some aspects, one or more other components of the apparatus 2200 may generate communications and may provide the generated communications to the transmission component 2204 for transmission to the apparatus 2208. In some aspects, the transmission component 2204 may perform signal processing on the generated communications, and may transmit the processed signals to the apparatus 2208. In some aspects, the transmission component 2204 may include one or more components of the wireless communication device described above in connection with FIG. 14, such as a radio, one or more RF chains, one or more transceivers, or one or more modems, each of which may in turn be coupled with one or more antennas of the wireless communication device described in connection with FIG. 14. In some aspects, the transmission component 2204 may be co-located with the reception component 2202.

The communication manager 2206 may support operations of the reception component 2202 or the transmission component 2204. For example, the communication manager 2206 may receive information associated with configuring reception of communications by the reception component 2202 or transmission of communications by the transmission component 2204. Additionally, or alternatively, the communication manager 2206 may generate or provide control information to the reception component 2202 or the transmission component 2204 to control reception or transmission of communications.

The reception component 2202 or the transmission component 2204 may communicate, with a network node using a plurality of antenna panels including a first antenna panel at a first location, one or more messages via a first communication beam corresponding to a first beam steering direction. The communication manager 2206 may perform a mechanical displacement of the first antenna panel from the first location to a second location. The communication manager 2206 may perform a beam refinement procedure for the plurality of antenna panels including the first antenna panel at the second location to select a second communication beam in coordination with a third communication beam associated with a second antenna panel. The reception component 2202 or the transmission component 2204 may communicate, with the network node using the first antenna panel at the second location, one or more messages via the second communication beam corresponding to a second beam steering direction that is correlated to the first beam steering direction according to a local coordinate system of the wireless communication device.

The transmission component 2204 may transmit an indication of the mechanical displacement of the first antenna panel to the network node.

The communication manager 2206 may correlate a beam steering direction of the second communication beam with the beam steering direction of the first communication beam according to the mechanical displacement of the first antenna panel.

The communication manager 2206 may determine a sticky beam set for the first antenna panel at the second location that corresponds to the second location of the first antenna panel and is stored in a codebook of the first antenna panel.

The transmission component 2204 may transmit, to the network node, an indication of the sticky beam set associated with the first antenna panel, wherein the sticky beam set includes the second communication beam.

The reception component may receive a set of reference signals corresponding to a set of co-phasing factors between the second communication beam and the third communication beam.

The communication manager 2206 may select a co-phasing factor from the set of co-phasing factors for coordinated communications via the second communication beam associated with the first antenna panel and the third communication beam associated with the second antenna panel.

The communication manager 2206 may communicate the one or more messages via the second communication beam using the first antenna panel and the third communication beam using the second antenna panel according to the co-phasing factor.

The transmission component 2204 may transmit, to the network node, an indication of the co-phasing factor.

The reception component 2202 may receive, from the network node, an indication of one or more beam refinement parameters associated with the first antenna panel at the second location.

The transmission component 2204 may transmit, to the network node, an indication to perform the beam refinement procedure again for the first antenna panel in accordance with at least one of an expiry of a timer, a detected change in local geometry of the wireless communication device, a detected change in local geometry of an environment of the wireless communication device, or a detected change in channel quality.

The reception component 2202 may receive, from the network node, an indication to adjust the mechanical displacement of the first antenna panel for identifying one or more TCI states associated with communications via the second antenna panel.

The transmission component 2204 may transmit, to the network node, one or more channel state reports associated with the first communication beam and the second communication beam.

The reception component 2202 may receive, from the network node, an indication of a TCI state associated with the second communication beam.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

FIG. 23 is a diagram of an example apparatus 2300 for wireless communication. The apparatus 2300 may be a network node, or a network node may include the apparatus 2300. In some aspects, the apparatus 2300 includes a reception component 2302, a transmission component 2304, or a communication manager 2306, which may be in communication with one another (for example, via one or more buses or one or more other components). In some aspects, the communication manager 2306 is the communication manager 1455 described in connection with FIG. 14. As shown, the apparatus 2300 may communicate with another apparatus 2308, such as a UE or a network node (such as a CU, a DU, an RU, or a base station), using the reception component 2302 and the transmission component 2304. The communication manager 2306 may be included in, or implemented via, a processing system (for example, the processing system 1445 described in connection with FIG. 14) of the network node.

In some aspects, the apparatus 2300 may be configured to perform one or more operations described herein in connection with FIGS. 18-19. Additionally, or alternatively, the apparatus 2300 may be configured to perform one or more processes described herein, such as process 2100 of FIG. 21, or a combination thereof. In some aspects, the apparatus 2300 or one or more components shown in FIG. 23 may include one or more components of the network node described in connection with FIG. 14. Additionally, or alternatively, one or more components shown in FIG. 23 may be implemented within one or more components described in connection with FIG. 14. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2302 may receive communications, such as reference signals, control information, data communications, or a combination thereof, from the apparatus 2308. The reception component 2302 may provide received communications to one or more other components of the apparatus 2300. In some aspects, the reception component 2302 may perform signal processing on the received communications, and may provide the processed signals to the one or more other components of the apparatus 2300. In some aspects, the reception component 2302 may include one or more components of the network node described above in connection with FIG. 14, such as a radio, one or more RF chains, one or more transceivers, or one or more modems, each of which may in turn be coupled with one or more antennas of the network node. In some aspects, the reception component 2302 or the transmission component 2304 may include or may be included in a network interface. The network interface may be configured to obtain or output signals for the apparatus 2300 via one or more communications links, such as a backhaul link, a midhaul link, or a fronthaul link.

The transmission component 2304 may transmit communications, such as reference signals, control information, data communications, or a combination thereof, to the apparatus 2308. In some aspects, one or more other components of the apparatus 2300 may generate communications and may provide the generated communications to the transmission component 2304 for transmission to the apparatus 2308. In some aspects, the transmission component 2304 may perform signal processing on the generated communications, and may transmit the processed signals to the apparatus 2308. In some aspects, the transmission component 2304 may include one or more components of the network node described above in connection with FIG. 14, such as a radio, one or more RF chains, one or more transceivers, or one or more modems, each of which may in turn be coupled with one or more antennas of the network node described in connection with FIG. 14. In some aspects, the transmission component 2304 may be co-located with the reception component 2302.

The communication manager 2306 may support operations of the reception component 2302 or the transmission component 2304. For example, the communication manager 2306 may receive information associated with configuring reception of communications by the reception component 2302 or transmission of communications by the transmission component 2304. Additionally, or alternatively, the communication manager 2306 may generate or provide control information to the reception component 2302 or the transmission component 2304 to control reception or transmission of communications.

The reception component 2302 or the transmission component 2304 may communicate, with a wireless communication device that is using a plurality of antenna panels including a first antenna panel at a first location, one or more messages via a first communication beam that corresponds to a first beam steering direction. The communication manager 2306 may perform, via one or more communications with the wireless communication device, a beam refinement procedure for communicating with the plurality of antenna panels including the first antenna panel at a second location to select a second communication beam in coordination with a third communication beam that is associated with a second antenna panel. The reception component 2302 or the transmission component 2304 may communicate, with the wireless communication device that is using the first antenna panel at the second location, one or more messages via the second communication beam corresponding to a second beam steering direction that is correlated to the first beam steering direction according to a local coordinate system of the wireless communication device.

The reception component 2302 may receive an indication of a mechanical displacement of the first antenna panel to the network node.

The reception component 2302 may receive, from the wireless communication device, an indication of a sticky beam set for the first antenna panel at the second location, wherein the sticky beam set includes the second communication beam.

The transmission component 2304 may select a set of reference signals corresponding to a set of co-phasing factors between the second communication beam and the third communication beam for selection of a co-phasing factor from the set of co-phasing factors.

The communication manager 2306 may communicate the one or more messages via the second communication beam from the first antenna panel and the third communication beam from the second antenna panel according to the co-phasing factor.

The reception component 2302 may receive, from the wireless communication device, an indication of the co-phasing factor for coordinated communications via the second communication beam associated with the first antenna panel and the third communication beam associated with the second antenna panel.

The transmission component 2304 may transmit, to the wireless communication device, an indication of one or more beam refinement parameters associated with the first antenna panel at the second location.

The reception component 2302 may receive, from the wireless communication device, an indication to perform the beam refinement procedure again for the plurality of antenna panels in accordance with at least one of an expiry of a timer, a detected change in local geometry of the wireless communication device, a detected change in local geometry of an environment of the wireless communication device, or a detected change in channel quality.

The transmission component 2304 may transmit, to the wireless communication device, an indication to adjust a mechanical displacement of the first antenna panel for identifying one or more TCI states associated with communications via the second antenna panel.

The reception component 2302 may receive, from the wireless communication device, one or more channel state reports associated with the first communication beam and the second communication beam.

The transmission component 2304 may transmit, to the wireless communication device, an indication of a TCI state associated with the second communication beam.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a UE. The method includes transmitting, to a network entity, beam information comprising a set of candidate beams for a first antenna panel and a second antenna panel of the UE, wherein the set of candidate beams is associated with a set of valid time-period ranges, and wherein the set of valid time-period ranges indicates time-periods of validity for the set of candidate beams; and performing, based on the beam information, a beam refinement process with the network entity for coherent communication with the first antenna panel and the second antenna panel.

Aspect 2 is the method of aspect 1, wherein at least one of the first antenna panel and the second antenna panel is a mechanically displaceable panel.

Aspect 3 is the method of any of aspects 1 to 2, where the method further includes receiving, from the network entity, a request for the set of valid time-period ranges for the set of candidate beams.

Aspect 4 is the method of aspect 3, where the method further includes transmitting, in response to the request, an indication of the set of valid time-period ranges for the set of candidate beams.

Aspect 5 is the method of aspect 4, wherein the set of candidate beams is a first set of candidate beams, and the set of valid time-period ranges is a first set of valid time-period ranges, wherein the method further includes transmitting, to the network entity, a second set of candidate beams, wherein the second set of candidate beams is associated with a second set of valid time-period ranges, and wherein the second set of valid time-period ranges occurs later than the first set of valid time-period ranges.

Aspect 6 is the method of any of aspects 1 to 2, wherein the beam information further includes the set of valid time-period ranges associated with the set of candidate beams.

Aspect 7 is the method of any of aspects 1 to 2, where the method further includes receiving, from the network entity, a beam refinement indication that triggers the beam refinement process, wherein the beam refinement indication is based on an expiry of a timer, and wherein performing the beam refinement process comprises performing, in response to the beam refinement indication, the beam refinement process.

Aspect 8 is the method of aspect 7, wherein the expiry of the timer is based on an absolute time threshold.

Aspect 9 is the method of aspect 8, where the method further includes receiving, from the network entity, timing information indicating the absolute time threshold.

Aspect 10 is the method of aspect 7, wherein the expiry of the timer is associated with a speed of the mechanically displaceable panel.

Aspect 11 is the method of aspect 7, wherein the expiry of the timer is based on a beam coherence time estimation for beams associated with the first antenna panel or the second antenna panel at a prior time that is before the expiry of the timer.

Aspect 12 is the method of aspect 7, wherein the expiry of the timer is based on a quality metric for communication between the UE and the network entity.

Aspect 13 is the method of aspect 12, wherein the quality metric includes one or more of: a reference signal received power (RSRP) of a signal between the UE and the network entity, or a change of a strength of the signal between the UE and the network entity.

Aspect 14 is the method of any of aspects 1 to 13, where the method further includes receiving, from the network entity, an indication of a beam update restriction, wherein the beam update restriction is based on a communication overhead on a control channel between the UE and the network entity to enable the beam refinement process; and refraining, in response to the indication of the beam update restriction, from performing the beam refinement process.

Aspect 15 is an apparatus for wireless communication at a UE, comprising: at least one memory; and at least one processor coupled to the at least one memory, the at least one processor is configured to perform the method of any of aspects 1 to 14.

Aspect 16 is the apparatus for wireless communication at a UE, comprising means for performing each step in the method of any of aspects 1 to 14.

Aspect 17 is an apparatus of any of aspects 15 to 16, further comprising a transceiver configured to receive or to transmit in association with the method of any of aspects 1 to 14.

Aspect 18 is a computer-readable medium (e.g., a non-transitory computer-readable medium) storing computer executable code at a UE, the code when executed by at least one processor causes the at least one processor to perform the method of any of aspects 1 to 14.

Aspect 19 is a method of wireless communication at a network entity. The method includes receiving, from a user equipment (UE), beam information comprising a set of candidate beams for a first antenna panel and a second antenna panel of the UE, wherein the set of candidate beams is associated with a set of validity time ranges, and wherein the set of validity time ranges indicates validity periods for the set of candidate beams; and performing, based on the beam information, a beam refinement process with the UE for at least one of the first antenna panel and the second antenna panel.

Aspect 20 is the method of aspect 19, wherein at least one of the first antenna panel and the second antenna panel is a mechanically displaceable panel.

Aspect 21 is the method of any of aspects 19 to 20, where the method further includes transmitting, to the UE, a request for the validity periods for the set of candidate beams.

Aspect 22 is the method of aspect 21, where the method further includes receiving, from the UE, an indication of the set of validity time ranges for the set of candidate beams.

Aspect 23 is the method of aspect 22, wherein the set of candidate beams is a first set of candidate beams, and the set of validity time ranges is a first set of validity time ranges, wherein the method further comprises receiving, from the UE, a second set of candidate beams, wherein the second set of candidate beams is associated with a second set of validity time ranges, and wherein the second set of validity time ranges is later than the first set of validity time ranges.

Aspect 24 is the method of aspect 20, wherein the beam information further includes the set of validity time ranges associated with the set of candidate beams.

Aspect 25 is the method of any of aspects 19 to 24, where the method further includes transmitting, to the UE, an indication of a beam update restriction, wherein the beam update restriction is based on a communication overhead on a control channel between the UE and the network entity; and refraining, based on the indication of the beam update restriction, from performing the beam refinement process with the UE.

Aspect 26 is an apparatus for wireless communication at a network entity, comprising: at least one memory; and at least one processor coupled to the at least one memory and, where the at least one processor is configured to perform the method of any of aspects 19 to 25.

Aspect 27 is the apparatus for wireless communication at a network entity, comprising means for performing each step in the method of any of aspects 19 to 25.

Aspect 28 is an apparatus of any of aspects 26 to 27, further comprising a transceiver configured to receive or to transmit in association with the method of any of aspects 19 to 25.

Aspect 29 is a computer-readable medium (e.g., a non-transitory computer-readable medium) storing computer executable code at a network entity, the code when executed by at least one processor causes the at least one processor to perform the method of any of aspects 19 to 25.

Aspect 30: A method of wireless communication performed by a wireless communication device, comprising: communicating, with a network node using a plurality of antenna panels including a first antenna panel at a first location, one or more messages via a first communication beam corresponding to a first beam steering direction; performing a mechanical displacement of the first antenna panel from the first location to a second location; performing a beam refinement procedure for the plurality of antenna panels including the first antenna panel at the second location to select a second communication beam in coordination with a third communication beam associated with a second antenna panel; and communicating, with the network node using the first antenna panel at the second location, one or more messages via the second communication beam corresponding to a second beam steering direction that is correlated to the first beam steering direction according to a local coordinate system of the wireless communication device.

Aspect 31: The method of Aspect 30, further comprising: transmitting an indication of the mechanical displacement of the first antenna panel to the network node.

Aspect 32: The method of any of Aspects 30-31, wherein the beam refinement procedure comprises: correlating a beam steering direction of the second communication beam with the beam steering direction of the first communication beam according to the mechanical displacement of the first antenna panel.

Aspect 33: The method of any of Aspects 30-32, further comprising: determining a sticky beam set for the first antenna panel at the second location that corresponds to the second location of the first antenna panel and is stored in a codebook of the first antenna panel.

Aspect 34: The method of Aspect 33, further comprising: transmitting, to the network node, an indication of the sticky beam set associated with the first antenna panel, wherein the sticky beam set includes the second communication beam.

Aspect 35: The method of any of Aspects 30-34, wherein the beam refinement procedure comprises: receiving a set of reference signals corresponding to a set of co-phasing factors between the second communication beam and the third communication beam; and selecting a co-phasing factor from the set of co-phasing factors for coordinated communications via the second communication beam associated with the first antenna panel and the third communication beam associated with the second antenna panel.

Aspect 36: The method of Aspect 35, further comprising: communicating the one or more messages via the second communication beam using the first antenna panel and the third communication beam using the second antenna panel according to the co-phasing factor.

Aspect 37: The method of any of Aspects 35-36, further comprising: transmitting, to the network node, an indication of the co-phasing factor.

Aspect 38: The method of any of Aspects 30-37, further comprising: receiving, from the network node, an indication of one or more beam refinement parameters associated with the first antenna panel at the second location.

Aspect 39: The method of any of Aspects 30-38, wherein the second communication beam is selected using the local coordinate system of the wireless communication device and a codebook associated with the first antenna panel.

Aspect 40: The method of any of Aspects 30-39, further comprising: transmitting, to the network node, an indication to perform the beam refinement procedure again for the first antenna panel in accordance with at least one of an expiry of a timer, a detected change in local geometry of the wireless communication device, a detected change in local geometry of an environment of the wireless communication device, or a detected change in channel quality.

Aspect 41: The method of Aspect 40, wherein one or more channel quality metrics associated with the second communication beam satisfy a degradation threshold.

Aspect 42: The method of any of Aspects 30-41, further comprising: receiving, from the network node, an indication to adjust the mechanical displacement of the first antenna panel for identifying one or more transmission configuration indicator (TCI) states associated with communications via the second antenna panel.

Aspect 43: The method of any of Aspects 30-42, further comprising: transmitting, to the network node, one or more channel state reports associated with the first communication beam and the second communication beam.

Aspect 44: The method of any of Aspects 30-43, further comprising: receiving, from the network node, an indication of a transmission configuration indicator (TCI) state associated with the second communication beam.

Aspect 45: A method of wireless communication performed by a network node, comprising: communicating, with a wireless communication device that is using a plurality of antenna panels including a first antenna panel at a first location, one or more messages via a first communication beam that corresponds to a first beam steering direction; performing, via one or more communications with the wireless communication device, a beam refinement procedure for communicating with the plurality of antenna panels including the first antenna panel at a second location to select a second communication beam in coordination with a third communication beam that is associated with a second antenna panel; and communicating, with the wireless communication device that is using the first antenna panel at the second location, one or more messages via the second communication beam corresponding to a second beam steering direction that is correlated to the first beam steering direction according to a local coordinate system of the wireless communication device.

Aspect 46: The method of Aspect 45, further comprising: receiving an indication of a mechanical displacement of the first antenna panel to the network node.

Aspect 47: The method of any of Aspects 45-46, further comprising: receiving, from the wireless communication device, an indication of a sticky beam set for the first antenna panel at the second location, wherein the sticky beam set includes the second communication beam.

Aspect 48: The method of any of Aspects 16-18, wherein the beam refinement procedure comprises: transmitting a set of reference signals corresponding to a set of co-phasing factors between the second communication beam and the third communication beam for selection of a co-phasing factor from the set of co-phasing factors.

Aspect 49: The method of Aspect 48, further comprising: communicating the one or more messages via the second communication beam from the first antenna panel and the third communication beam from the second antenna panel according to the co-phasing factor.

Aspect 50: The method of any of Aspects 48-49, further comprising: receiving, from the wireless communication device, an indication of the co-phasing factor for coordinated communications via the second communication beam associated with the first antenna panel and the third communication beam associated with the second antenna panel.

Aspect 51: The method of any of Aspects 45-50, further comprising: transmitting, to the wireless communication device, an indication of one or more beam refinement parameters associated with the first antenna panel at the second location.

Aspect 52: The method of any of Aspects 45-51, wherein the second communication beam is selected using the local coordinate system of the wireless communication device and a codebook associated with the first antenna panel.

Aspect 53: The method of any of Aspects 45-52, further comprising: receiving, from the wireless communication device, an indication to perform the beam refinement procedure again for the plurality of antenna panels in accordance with at least one of an expiry of a timer, a detected change in local geometry of the wireless communication device, a detected change in local geometry of an environment of the wireless communication device, or a detected change in channel quality.

Aspect 54: The method of any of Aspects 45-53, wherein one or more channel quality metrics associated with the second communication beam satisfy a degradation threshold.

Aspect 55: The method of any of Aspects 45-54, further comprising: transmitting, to the wireless communication device, an indication to adjust a mechanical displacement of the first antenna panel for identifying one or more transmission configuration indicator (TCI) states associated with communications via the second antenna panel.

Aspect 56: The method of Aspect 55, further comprising: receiving, from the wireless communication device, one or more channel state reports associated with the first communication beam and the second communication beam.

Aspect 57: The method of any of Aspects 45-56, further comprising: transmitting, to the wireless communication device, an indication of a transmission configuration indicator (TCI) state associated with the second communication beam.

Aspect 58: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 30-57.

Aspect 59: An apparatus for wireless communication at a device, the apparatus comprising one or more memories and one or more processors coupled to the one or more memories, the one or more processors configured to cause the device to perform the method of one or more of Aspects 30-57.

Aspect 60: An apparatus for wireless communication, the apparatus comprising at least one means for performing the method of one or more of Aspects 30-57.

Aspect 61: A non-transitory computer-readable medium storing code for wireless communication, the code comprising instructions executable by one or more processors to perform the method of one or more of Aspects 30-57.

Aspect 62: A non-transitory computer-readable medium storing a set of instructions for wireless communication, the set of instructions comprising one or more instructions that, when executed by one or more processors of a device, cause the device to perform the method of one or more of Aspects 30-57.

Aspect 63: A device for wireless communication, the device comprising a processing system that includes one or more processors and one or more memories coupled with the one or more processors, the processing system configured to cause the device to perform the method of one or more of Aspects 30-57.

Aspect 64: An apparatus for wireless communication at a device, the apparatus comprising one or more memories and one or more processors coupled to the one or more memories, the one or more processors individually or collectively configured to cause the device to perform the method of one or more of Aspects 30-57.

Aspect 65: A device comprising a processing system that includes one or more processors and one or more code-storing memories coupled with the one or more processors, the processing system configured to cause the device to perform the method of one or more of Aspects 30-57.

Aspect 66: A device comprising a processing system that includes processor circuitry and code-storing memory circuitry, the processing system configured to cause the device to perform the method of one or more of Aspects 30-57.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
transmit, to a network entity, beam information comprising a set of candidate beams for a first antenna panel and a second antenna panel of the UE, wherein the set of candidate beams is associated with a set of valid time-period ranges, and wherein the set of valid time-period ranges indicates time-periods of validity for the set of candidate beams; and
perform, based on the beam information, a beam refinement process with the network entity for coherent communication with the first antenna panel and the second antenna panel.

2. The apparatus of claim 1, further comprising a transceiver coupled to the at least one processor, wherein to transmit the beam information, the at least one processor is configured to transmit the beam information via the transceiver, wherein at least one of the first antenna panel and the second antenna panel is a mechanically displaceable panel.

3. The apparatus of claim 2, wherein the at least one processor is further configured to:
receive, from the network entity, a request for the set of valid time-period ranges for the set of candidate beams.

4. The apparatus of claim 3, wherein the at least one processor is further configured to:
transmit, in response to the request, an indication of the set of valid time-period ranges for the set of candidate beams.

5. The apparatus of claim 4, wherein the set of candidate beams is a first set of candidate beams, and the set of valid time-period ranges is a first set of valid time-period ranges, and wherein the at least one processor is further configured to:
transmit, to the network entity, a second set of candidate beams, wherein the second set of candidate beams is associated with a second set of valid time-period ranges, and wherein the second set of valid time-period ranges occurs later than the first set of valid time-period ranges.

6. The apparatus of claim 2, wherein the beam information further includes the set of valid time-period ranges associated with the set of candidate beams.

7. The apparatus of claim 2, wherein the at least one processor is further configured to:
receive, from the network entity, a beam refinement indication that triggers the beam refinement process, wherein the beam refinement indication is based on an expiry of a timer, and wherein to perform the beam refinement process, the at least one processor is configured to:
perform, in response to the beam refinement indication, the beam refinement process.

8. The apparatus of claim 7, wherein the expiry of the timer is based on an absolute time threshold.

9. The apparatus of claim 8, wherein the at least one processor is further configured to:
receive, from the network entity, timing information indicating the absolute time threshold.

10. The apparatus of claim 7, wherein the expiry of the timer is associated with a speed of the mechanically displaceable panel.

11. The apparatus of claim 7, wherein the expiry of the timer is based on a beam coherence time estimation for beams associated with the first antenna panel or the second antenna panel at a prior time that is before the expiry of the timer.

12. The apparatus of claim 7, wherein the expiry of the timer is based on a quality metric for communication between the UE and the network entity.

13. The apparatus of claim 12, wherein the quality metric includes one or more of:
a reference signal received power (RSRP) of a signal between the UE and the network entity, or
a change of a strength of the signal between the UE and the network entity.

14. The apparatus of claim 2, wherein the at least one processor is further configured to:
receive, from the network entity, an indication of a beam update restriction, wherein the beam update restriction is based on a communication overhead on a control channel between the UE and the network entity to enable the beam refinement process; and
refrain, in response to the indication of the beam update restriction, from performing the beam refinement process.

15. An apparatus for wireless communication at a network entity, comprising:
at least one memory; and
at least one processor coupled to the at least one memory and, based at least in part on information stored in the at least one memory, the at least one processor is configured to:
receive, from a user equipment (UE), beam information comprising a set of candidate beams for a first antenna panel and a second antenna panel of the UE, wherein the set of candidate beams is associated with a set of validity time ranges, and wherein the set of validity time ranges indicates validity periods for the set of candidate beams; and
perform, based on the beam information, a beam refinement process with the UE for at least one of the first antenna panel and the second antenna panel.

16. The apparatus of claim 15, further comprising a transceiver coupled to the at least one processor, wherein to receive the beam information, the at least one processor is configured to receive the beam information via the transceiver, wherein at least one of the first antenna panel and the second antenna panel is a mechanically displaceable panel.

17. The apparatus of claim 16, wherein the at least one processor is further configured to:
transmit, to the UE, a request for the validity periods for the set of candidate beams.

18. The apparatus of claim 17, wherein the at least one processor is further configured to:
receive, from the UE, an indication of the set of validity time ranges for the set of candidate beams.

19. The apparatus of claim 18, wherein the set of candidate beams is a first set of candidate beams, and the set of validity time ranges is a first set of validity time ranges, and wherein the at least one processor is further configured to:
receive, from the UE, a second set of candidate beams, wherein the second set of candidate beams is associated with a second set of validity time ranges, and wherein the second set of validity time ranges is later than the first set of validity time ranges.

20. A method of wireless communication at a user equipment (UE), comprising:
transmitting, to a network entity, beam information comprising a set of candidate beams for a first antenna panel and a second antenna panel of the UE, wherein the set of candidate beams is associated with a set of valid time-period ranges, and wherein the set of valid time-period ranges indicates time-periods of validity for the set of candidate beams; and
performing, based on the beam information, a beam refinement process with the network entity for a coherent communication with the first antenna panel and the second antenna panel.
